(19) United States
(12) Patent Application Publication
(10) Pub. No.: US 2021/0298052 A1
(43) Pub. Date: Sep. 23, 2021

(54) TERMINAL APPARATUS AND BASE STATION APPARATUS

(71) Applicant: SHARP KABUSHIKI KAISHA, Sakai City, Osaka (JP)

(72) Inventors: HIDEO NAMBA, Sakai City, Osaka (JP); JUNGO GOTO, Sakai City, Osaka (JP); OSAMU NAKAMURA, Sakai City, Osaka (JP)

(21) Appl. No.: 17/265,369

(22) PCT Filed: Aug. 5, 2019
(86) PCT No.: PCT/JP2019/030780

§ 371 Date: Feb. 2, 2021

(30) Foreign Application Priority Data
Aug. 7, 2018 (JP) 2018-148469

(51) Int. Cl. H04W 72/12; H04L 1/18

(52) U.S. Cl. CPC H04W 72/1278; H04W 72/14; H04L 1/1812

(57) ABSTRACT

A base station apparatus, a terminal apparatus, and a communication method are provided that can distinguish eMBB traffic from URLLC traffic in an uplink. A control information detection unit configured to detect RRC and first DCI or second DCI and a transmitter configured to perform one of first data transmission and second data transmission are included, wherein at least two BPWs are configured for a serving cell, only one of the at least two BWPs is activated, a BWP-specific configuration included in the RRC enables the second DCI to configure second data transmission based on the configuration, first data transmission notified in first DCI transmits data allows data to be transmitted in an active BWP, second data transmission notified in second DCI allows data to be transmitted in the BWP configured with the second data transmission, and in a case that the second DCI is detected and that the BWP configured with the second data transmission is deactivated, the BWP configured with the second data transmission is configured to be activate.

### TECHNICAL FIELD

The present invention relates to a base station apparatus, a terminal apparatus, and a communication method for these apparatuses. This application claims priority based on Japanese Patent Application No. 2018-148469 filed in Japan on Aug. 7, 2018, the contents of which are incorporated herein by reference.

### BACKGROUND ART

In recent years, 5th Generation (5G) mobile telecommunication systems have been focused on, and a communication technology is expected to be specified, the technology establishing MTC mainly based on a large number of terminal apparatuses (Massive Machine Type Communications; mMTC), Ultra-reliable and low latency communications (URLLC), and enhanced Mobile BroadBand (eMBB). The 3rd Generation Partnership Project (3GPP) has been studying New Radio (NR) as a 5G communication technique and discussing NR Multiple Access (MA).

In 5G, Internet of Things (loT) is expected to be established that allows connection of various types of equipment not previously connected to a network, and establishment of mMTC is an important issue. In 3GPP, a Machine-to-Machine (M2M) communication technology has already been standardized as Machine Type Communication (MTC) that accommodates terminal apparatuses transmitting and/or receiving small size data (NPL 1). Furthermore, in order to support data transmission at a low rate in a narrow band, specification of Narrow Band-IoT (NB-IoT) has been conducted (NPL 2). 5G is expected to accommodate more terminals than the above-described standards and to accommodate IoT equipment requiring ultra-reliable and low-latency communications.

On the other hand, in communication systems such as Long Term Evolution (LTE) and LTE-Advanced (LTE-A) which are specified by the 3GPP, terminal apparatuses (User Equipment (UE)) use a Random Access Procedure, a Scheduling Request (SR), and the like, to request a radio resource for transmitting uplink data to a base station apparatus (also referred to as a Base Station (BS) or an evolved Node B (eNB)). The base station apparatus provides uplink grant (UL Grant) to each terminal apparatus based on an SR. In a case that the terminal apparatus receives UL Grant for control information from the base station apparatus, the terminal apparatus transmits uplink data using a given radio resource (referred to as Scheduled access, grant-based access, or transmission based on dynamic scheduling, and hereinafter referred to as scheduled access), based on an uplink transmission parameter included in the UL Grant. In this manner, the base station apparatus controls all uplink data transmissions (the base station apparatus knows radio resources for uplink data transmitted by each terminal apparatus). In the scheduled access, the base station apparatus can establish Orthogonal Multiple Access (OMA) by controlling uplink radio resources.

5G rnMTC includes a problem in that the use of the scheduled access increases the amount of control information. URLLC includes a problem in that the use of the scheduled access increases delay. Thus, studies have been conducted about the utilization of grant free access (also referred to as grant less access, Contention-based access, Autonomous access, Resource allocation for uplink transmission without grant, configured grant type1 transmission, or the like; hereinafter referred to as grant free access) has been studied in which the terminal apparatus transmits data without performing any random access procedure or SR transmission and without performing UL Grant reception or the like, and semi-persistent scheduling (SPS, also referred to as configured grant type2 transmission or the like) (NPL 3). In the grant free access, increased overhead associated with control information can be suppressed even in a case that a large number of devices transmit small size data. Furthermore, in the grant free access, no UL Grant reception or the like is performed, and thus the time from generation until transmission of transmission data can be shortened. In the SPS, some of the transmission parameters are notified in higher-layer control information, and notified along with transmission parameters not notified in the higher layer, using a UL Grant for activation indicating the grant of periodic resources, so data transmission is enabled.

In 5G, up to four Band Width Parts (BWPs) may be configured in one serving cell, and subcarrier spacing and bandwidth may be set for each BWP. For this reason, wideband BWPs can be used for eMBB, narrowband BWPs can be used for mMTC, and BWPs with a wide subcarrier spacing (a short OFDM symbol length) can be used for URLLC. The BWPs can be dynamically switched using DCI formats 0_1 and 1_1.

Additionally, in URLLC, studies have been conducted about ensuring of high reliability of control information for the UL Grant and the DL Grant (PDCCH) as well as high reliability of data. For example, studies have been conducted about introduction of a Compact DCI format in which the UL Grant and the DL Grant can be transmitted at a low coding rate. In this case, with a given aggregation level, a DCI format having a large number of information bits has a higher coding rate than that of a DCI format having a small number of information bits. Thus, studies have been conducted to use, as the Compact DCI format, a DCI format having the number of information bits even smaller than the number of information bits in each of the existing DCI formats 0_0 and 1_0. Here, DCI formats 0_0 and 1_0 are formats having fewer information bits than those of each of DCI formats 0_1 and 1_1.

### CITATION LIST

### Non Patent Literature

NPL 1: 3GPP, TR36.888 V12.0.0, “Study on provision of low-cost Machine-Type Communications (MTC) User Equipments (UEs) based on LTE,” June 2013

NPL 2: 3GPP, TR45.820 V13.0.0, “Cellular system support for ultra-low complexity and low throughput Internet of Things (CIoT),” August 2015

NPL 3: 3GPP TS38.214 V15.1.0, “Physical layer procedures for data (Release 15),” March 2018

### SUMMARY OF INVENTION

### Technical Problem

For URLLC for which high reliability and low latency is required, the DCI format is preferably used to switch to BWPs with a wide subcarrier spacing and to apply repeated transmission of the same data or data transmission at a low coding rate. However, the DCI format that can be used for switching of the BWPs is supported only in DCI format 0_1 or 1_1, which corresponds to transmission at a high coding rate, and disadvantageously the control information has lower reliability than that of the data.

In view of such circumstances, an object of an aspect of the present invention is to provide a base station apparatus, a terminal apparatus, and a communication method that can provide data with low latency and high reliability.

### Solution to Problem

To address the above-mentioned drawbacks, a base station apparatus, a terminal apparatus, and a communication method according to an aspect of the present invention are configured as follows.

(1) An aspect of the present invention is a terminal apparatus including a control information detection unit configured to detect first Downlink Control Information (DCI) and second DCI notifying Radio Resource Control (RRC) information and an uplink grant, and a transmitter configured to perform data transmission indicated in the first DCI or the second DCI, wherein at least a first BandWidth Part (BPW) and a second BPW are configured for the at least one serving cell according to the first RRC information, the second DCI is associated with the second BWP according to the second RRC information, an amount of information of the first DCI differs from an amount of information of the second DCI, the second DCI does not include a switching information bit for switching between the first BWP and the second BWP, and the transmitter performs the data transmission in a BWP that is active and corresponds to one of the first BWP and the second BWP, and in a case that the control information detection unit detects the second DCI in the first BWP, the second BWP is activated, and the data transmission is performed in the second BWP.

(2) An aspect of the present invention is the terminal apparatus wherein, in a case that the second BWP is active and that HARQ processes used for the data transmission in the second BWP are all completed, the second BWP is deactivated.

(3) An aspect of the present invention is the terminal apparatus wherein, in a case that the control information detection unit detects the second DCI in the first BWP, an inactivity timer is started, and the second BWP is deactivated in a case that the inactive timer expires.

(4) An aspect of the present invention is the terminal apparatus wherein, in a case that a third BWP is further configured according to the first RRC information, an information field, configured in the second DCI, for indicating one of a plurality of the BWPs is added.

(5) An aspect of the present invention is the terminal apparatus wherein, in a case that a fourth BWP is further configured according to the first RRC information, a bit length of the added information field for indicating the one of the plurality of the BWPs is changed.

(6) An aspect of the present invention is a terminal apparatus including a control information detection unit configured to detect first Downlink Control Information (DCI) and second DCI notifying Radio Resource Control (RRC) information and an uplink grant, and a transmitter configured to perform data transmission indicated in the first DCI or the second DCI, wherein at least a first BandWidth Part (BPW) and a second BWP are configured for the at least one serving cell according to the first RRC information, at least a first Radio Network Temporary Identifier (RNTI) and a second RNTI are configured as RNTIs to be used in the second DCI according to the third RRC information, the first BWP is activated in a case that use of the first RNTI in the second DCI is detected, and the second BWP is activated in a case that use of the first RNTI in the second DCI is detected.

(7) An aspect of the present invention is a terminal apparatus including a control information detection unit configured to detect Radio Resource Control (RRC) information and a transmitter, wherein at least a first BandWidth Part (BPW) and a second BWP are configured for the at least one serving cell according to first RRC information, at least a resource for a first scheduling request and a resource for a second scheduling request are configured according to fourth RRC information, an uplink transmission using the first BWP is requested in a case that the resource for the first scheduling request is used, and an uplink transmission using the second BWP is requested in a case that the resource for the second scheduling request is used.

(8) An aspect of the present invention is a base station apparatus including a controller configured to control generation of first Downlink Control Information (DCI) and second DCI for notifying Radio Resource Control (RRC) information and an uplink grant, a transmitter configured to transmit one of the first DCI, the second DCI, and the RRC information, and a receiver configured to receive a signal transmitted from the terminal apparatus, wherein at least a first BandWidth Part (BPW) and a second BPW are configured for the at least one serving cell according to first RRC information, the second DCI is associated with the second BWP according to second RRC information, an amount of information of the first DCI differs from an amount of information of the second DCI, the second DCI does not include a switching information bit for switching between the first BWP and the second BWP, and the receiver receives a signal transmitted using a BWP that is active and corresponds to one of the first BWP and the second BWP from the terminal apparatus, and in a case that the second DCI is transmitted in the first BWP, the second BWP is activated and the signal transmitted from the terminal apparatus is received in the second BWP.

### Advantageous Effects of Invention

According to one or more aspects of the present invention, efficient uplink data transmission can be achieved.

### BRIEF DESCRIPTION OF DRAWINGS

FIG. 1 is a diagram illustrating an example of a communication system according to a first embodiment.

FIG. 2 is a diagram illustrating an example of a radio frame structure for the communication system according to the first embodiment.

FIG. 3 is a schematic block diagram illustrating a configuration of a base station apparatus 10 according to the first embodiment.

FIG. 4 is a diagram illustrating an example of a signal detection unit according to the first embodiment.

FIG. 5 is a schematic block diagram illustrating a configuration of a terminal apparatus 20 according to the first embodiment.

FIG. 6 is a diagram illustrating an example of the signal detection unit according to the first embodiment.

FIG. 7 is a diagram illustrating an example of a sequence chart of uplink data transmission for dynamic scheduling.

FIG. 8 is a diagram illustrating an example of a sequence chart of uplink data transmission related to configured grant.

FIG. 9 is a diagram illustrating an example of a sequence chart of uplink data transmission related to the configured grant.

FIG. 10 is a diagram illustrating a BWP switching operation in one serving cell according to the first embodiment.

FIG. 11 is a diagram illustrating an example of ACK transmission for uplink configured grant according to a fourth embodiment.

FIG. 12 is a diagram illustrating an example of the ACK transmission for uplink configured grant according to the fourth embodiment.

FIG. 13 is a diagram illustrating an example of ACK transmission for uplink configured grant according to a fifth embodiment.

### DESCRIPTION OF EMBODIMENTS

A communication system according to the present embodiment includes a base station apparatus (also referred to as a cell, a small cell, a pico cell, a serving cell, a component carrier, an eNodeB (eNB), a Home eNodeB, a Low Power Node, a Remote Radio Head, a gNodeB (gNB), a control station, a Bandwidth Part (BWP), or a Supplementary Uplink (SUL)), and a terminal apparatus (also referred to as a terminal, a mobile terminal, a mobile station, or User Equipment (UE)). In the communication system, in case of a downlink, the base station apparatus serves as a transmitting apparatus (a transmission point, a transmit antenna group, or a transmit antenna port group), and the terminal apparatus serves as a receiving apparatus (a reception point, a reception terminal, a receive antenna group, or a receive antenna port group). In a case of an uplink, the base station apparatus serves as a receiving apparatus, and the terminal apparatus serves as a transmitting apparatus. The communication system is also applicable to Device-to-Device (D2D) communication. In this case, the terminal apparatus serves both as a transmitting apparatus and as a receiving apparatus.

The communication system is not limited to data communication between the terminal apparatus and the base station apparatus, the communication involving human beings, but is also applicable to a form of data communication requiring no human intervention, such as Machine Type Communication (MTC), Machine-to-Machine (M2M) Communication, communication for Internet of Things (IoT), or Narrow Band-IoT (NB-IoT) (hereinafter referred to as MTC). In this case, the terminal apparatus serves as an MTC terminal. The communication system can use, in the uplink and the downlink, a multicarrier transmission scheme such as Discrete Fourier Transform Spread-Orthogonal Frequency Division Multiplexing (DFTS-OFDM, also referred to as Single Carrier-Frequency Division Multiple Access (SC-FDMA)), Cyclic Prefix-Orthogonal Frequency Division Multiplexing (CP-OFDM), and the like. The communication system can also use Filter Bank Multi Carrier (FBMC), Filtered-OFDM (f-OFDM) to which a filter is applied, Universal Filtered-OFDM (UF-OFDM), or Windowing-OFDM (W-OFDM), a transmission scheme using a sparse code (Sparse Code Multiple Access (SCMA)), or the like. Furthermore, the communication system may apply DFT precoding and use a signal waveform for which the filter described above is used. Furthermore, the communication system may apply code spreading, interleaving, the sparse code, and the like in the above-described transmission scheme. Note that, in the description below, at least one of the DFTS-OFDM transmission and the CP-OFDM transmission is used in the uplink, whereas the CP-OFDM transmission is used in the downlink but that the present embodiments are not limited to this configuration and any other transmission scheme is applicable.

The base station apparatus and the terminal apparatus according to the present embodiments can communicate in a frequency band for which an approval of use (license) has been obtained from the government of a country or region where a radio operator provides services, that is, a so-called licensed band, and/or in a frequency band for which no approval (license) from the government of the country or region is required, that is, a so-called unlicensed band. In the unlicensed band, communication may be based on carrier sense (e.g., a listen before talk scheme).

According to the present embodiments, “X/Y” includes the meaning of “X or Y”. According to the present embodiments, “X/Y” includes the meaning of “X and Y”. According to the present embodiments, “X/Y” includes the meaning of “X and/or Y”.

### First Embodiment

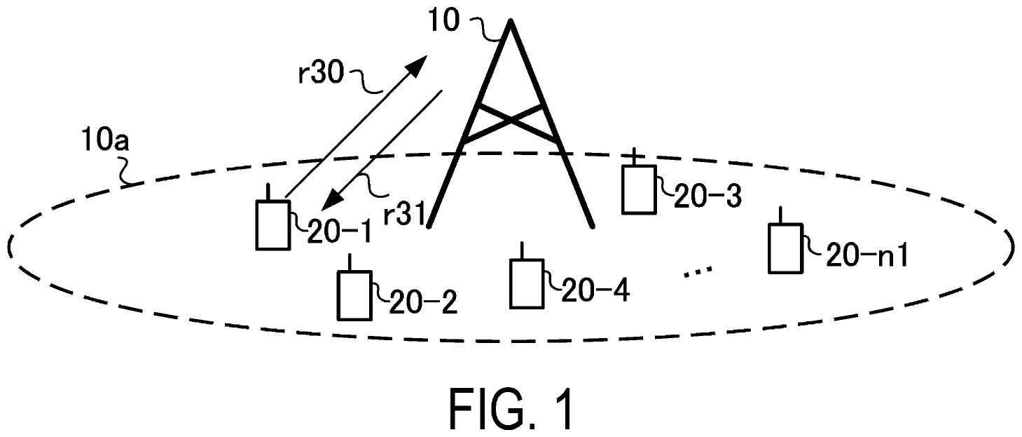

FIG. 1 is a diagram illustrating an example of a configuration of a communication system according to the present embodiment. The communication system according to the present embodiment includes a base station apparatus 10 and terminal apparatuses 20-1 to 20-n1 (n1 is a number of terminal apparatuses connected to the base station apparatus 10). The terminal apparatuses 20-1 and 20-n1 are also collectively referred to as terminal apparatuses 20. Coverage 10a is a range (a communication area) in which the base station apparatus 10 can connect to the terminal apparatus 20 (coverage 10a is also referred to as a cell).

In FIG. 1, an uplink radio communication r30 at least includes the following uplink physical channels. The uplink physical channels are used for transmitting information output from a higher layer.
Physical Uplink Control Channel (PUCCH)
Physical Uplink Shared Channel (PUSCH)
Physical Random Access Channel (PRACH)

The PUCCH is a physical channel that is used to transmit Uplink Control Information (UCI). The uplink control information includes a positive acknowledgement (ACK)/Negative acknowledgement (NACK) in response to downlink data (a Downlink transport block, a Medium Access Control Protocol Data Unit (MAC PDU), a Downlink-Shared Channel (DL-SCH), and a Physical Downlink Shared Channel (PDSCH). The ACK/NACK is also referred to as a Hybrid Automatic Repeat request ACKnowledgement (HARQ-ACK), a HARQ feedback, a HARQ response, or a signal indicating HARQ control information or a delivery confirmation.

The uplink control information includes a Scheduling Request (SR) used to request a PUSCH (Uplink-Shared Channel (UL-SCH)) resource for initial transmission. The scheduling request includes a positive scheduling request or a negative scheduling request. The positive scheduling request indicates that a UL-SCH resource for initial transmission is requested. The negative scheduling request indicates that the UL-SCH resource for the initial transmission is not requested.

The uplink control information includes downlink Channel State Information (CSI). The downlink channel state information includes a Rank Indicator (RI) indicating a preferable spatial multiplexing order (the number of layers), a Precoding Matrix Indicator (PMI) indicating a preferable precoder, a Channel Quality Indicator (CQI) designating a preferable transmission rate, and the like. The PMI indicates a codebook determined by the terminal apparatus. The codebook is related to precoding of the physical downlink shared channel. The CQI can use an index (CQI index) indicative of a preferable modulation scheme (for example, QPSK, 16QAM, 64QAM, 256QAM, or the like), a preferable coding rate, and a preferable frequency utilization efficiency in a prescribed band. The terminal apparatus selects, from the CQI table, a CQI index considered to allow a transport block on the PDSCH to be received within a prescribed block error probability (for example, an error rate of 0.1). Here, the terminal apparatus may have multiple prescribed error probabilities (error rates) for transport blocks. For example, a block error rate for eMBB data may be targeted at 0.1 and a block error rate for URLLC data may be targeted at 0.00001. The terminal apparatus may perform CST feedback for each target error rate (transport block error rate) in a case of configuration in a higher layer (e.g., setup through RRC signaling from a base station), or may perform CST feedback of a target error rate configured in a case that, in the higher layer, one of multiple target error rates is configured in the higher layer. Note that the CST may be calculated using an error rate that is not an error rate for eMBB (e.g., 0.1), depending on whether or not a CQI table that is not a CQI table for eMBB (that is, transmission having a BLER not exceeding 0.1) has been selected, instead of whether the error rate is configured by RRC signaling.

For the PUCCH, PUCCH formats 0 to 4 are defined, and PUCCH formats 0 and 2 are transmitted in one or two OFDM symbols, and PUCCH formats 1, 3, and 4 are transmitted in four to 14 OFDM symbols. PUCCH formats 0 and 1 are used for notification of two or less bits, and can exclusively notify the HARQ-ACK or the SR or simultaneously notify the HARQ-ACK and the SR. PUCCH formats 1, 3, and 4 are used for notification of more than two bits, and can simultaneously notify the HARQ-ACK, the SR, and the CSI. The number of OFDM symbols used for transmission of the PUCCH is configured in the higher layer (e.g., setup through RRC signaling), and which PUCCH format is to be used depends on whether there is an SR transmission or a CSI transmission at a timing (slot or OFDM symbol) when the PUCCH is transmitted.

PUCCH-config, indicating configuration information (configuration) regarding the PUCCH, includes whether any of PUCCH formats 1 to 4 is used, PUCCH resources (starting physical resource block and PRB-1d), information regarding the association of the PUCCH format that can be used for each PUCCH resource, and a configuration of intra-slot hopping, and also includes SchedulingRequestResourceConfig, indicating SR configuration information. The SR configuration information includes a scheduling request ID, the period and offset of a scheduling request, and information regarding the PUCCH resources to be used. Note that the scheduling request ID is used for associating an SR prohibition timer configured in SchedulingRequestConfig in MAC-CellGroupConfig with the configuration of the maximum number of SR transmissions.

The PUSCH is a physical channel used to transmit uplink data (Uplink Transport Block, Uplink-Shared Channel (UL-SCH)). The PUSCH may be used to transmit the HARQ-ACK in response to the downlink data and/or the channel state information along with the uplink data. The PUSCH may be used to transmit only the channel state information. The PUSCH may be used to transmit only the HARQ-ACK and the channel state information.

The PUSCH is used to transmit radio resource control (Radio Resource Control (RRC)) signaling. The RRC signaling is also referred to as an RRC message/RRC layer information/an RRC layer signal/an RRC layer parameter/RRC information/an RRC information element. The RRC signaling is information/signal processed in a radio resource control layer. The RRC signaling transmitted from the base station apparatus may be signaling common to multiple terminal apparatuses in a cell. The RRC signaling transmitted from the base station apparatus may be signaling dedicated to a certain terminal apparatus (also referred to as dedicated signaling). In other words, UE-specific information is transmitted through signaling dedicated to the certain terminal apparatus. The RRC message can include a UE Capability of the terminal apparatus. The UE Capability is information indicating a function supported by the terminal apparatus.

The PUSCH is used to transmit a Medium Access Control Element (MAC CE). The MAC CE is information/signal processed (transmitted) in a Medium Access Control layer. For example, a Power Headroom (PH) may be included in the MAC CE and may be reported via the physical uplink shared channel. In other words, a MAC CE field is used to indicate a level of the power headroom. The uplink data can include the RRC message and the MAC CE. Transmission and exchange of the RRC message may correspond to the RRC signaling. The RRC signaling and/or the MAC CE is also referred to as a higher layer signal (higher layer signaling). The RRC signaling and/or the MAC CE are included in a transport block.

The PUSCH may be used for data transmission for dynamic scheduling (allocation of dynamic radio resources) in which uplink data transmission is performed using specified radio resources, based on uplink transmission parameters (e.g., time domain resource allocation, frequency domain resource allocation, etc.) included in the DCI format. The PUSCH may be used for data transmission of DL Semi-Persistent scheduling (SPS) or Configured grant Type2 (Configured uplink grant type2) for which the data transmission using periodic radio resources is allowed by receiving DCI format 0_0/0_1/1_0/1_1 in which the CRC is scrambled with CS-RNTI is received, and further receiving activation control information in which Validation of the received DCI format 0_0/0_1/1_0/1_1 is configured in a prescribed field, after reception of frequency hopping by ConfiguredGrantConfig of RRC, a DMRS configuration, an mcs table, a mcs table transform precoder, uci-onPUSCH, a resource allocation type, an RBG size, closed loop transmission power control (powerControlLoopToUse), target received power and a set (p0-PUSCH-Alpha), TransformPrecoder (precoder), nrofHARQ (the number of HARQ processes), the number of repeated transmissions of the same data (repK), repK-RV (pattern of redundancy versions during repeated transmissions of the same data), the periods of Configured Grant Type1 and Type2, and a timer for reception of NACK for Configured Grant. Here, the field used for the Validation may include all the bits of the HARQ process number, 2 bits of the RV, and the like. Additionally, the field used for Validation of control information for the deactivation (release) of configured grant type2 transmission may include all bits of the HARQ process number, all bits of the MCS, all bits of the resource block assignment, 2 bits of the RV, and the like. Furthermore, the PUSCH may be used for configured grant type1 transmission in which periodic data transmission is allowed by receiving, under RRC, rrcConfiguredUplinkGrant in addition to configured grant type2 transmission information. The rrcConfiguredUplinkGrant information may include resource allocation for the time domain, offset for the time domain, resource allocation for the frequency domain, an antenna port, and sequence initialization for the DMRS, precoding and the number of layers, an SRS resource indicator, mcs and TBS, a frequency hopping offset, and a path loss reference index. Additionally, in a case that configured grant type1 transmission and configured type2 grant transmission are configured in the same serving cell (in the component carrier), configured grant type1 transmission may be prioritized. In addition, in a case that, in the same serving cell, the uplink grant for configured grant type1 transmission and the uplink grant for dynamic scheduling overlap in the time domain, the uplink grant for dynamic scheduling may override the uplink grant for configured grant type1 transmission (only the dynamic scheduling is used, and the uplink grant for configured grant type1 transmission is negated). In addition, the overlapping of the multiple uplink grants in the time domain may refer to overlapping in at least some of the OFDM symbols, and in a case of different subcarrier spacings (SCSs), the overlapping of the multiple uplink grants in the time domain may refer to partial overlapping of the time in the OFDM symbols due to a difference in OFDM symbol length. configured grant type1 transmission may be configured for a Secondary Cell (SCell) not activated by RRC as well as for a Primary Cell (PCell), and after the SCell configured with configured grant type1 transmission is activated, the uplink grant for configured grant type1 transmission is enabled.

The PRACH is used to transmit a preamble used for random access. The PRACH is used for indicating the initial connection establishment procedure, the handover procedure, the connection re-establishment procedure, synchronization (timing adjustment) for uplink transmission, and the request for the PUSCH (UL-SCH) resource.

In the uplink radio communication, an Uplink Reference Signal (UL RS) is used as an uplink physical signal. The uplink reference signal includes a Demodulation Reference Signal (DMRS) and a Sounding Reference Signal (SRS). The DMRS is associated with transmission of the physical uplink-shared channel/physical uplink control channel. For example, the base station apparatus 10 uses the demodulation reference signal to perform channel estimation/channel compensation in a case of demodulating the physical uplink-shared channel/the physical uplink control channel. For the uplink DMRS, the maximum number of OFDM symbols for a front-loaded DMRS and configuration of addition of DMRS symbols (DMRS-add-pos) are specified by the base station apparatus via the RRC. In a case that the front-loaded DMRS corresponds to one OFDM symbol (single symbol DMRS), the DCI is used to specify frequency domain allocation, the value of a cyclic shift in the frequency domain, and the degree of difference in frequency domain allocation used for OFDM symbols including the DMRS. In a case that the front-loaded DMRS corresponds to two OFDM symbols (double symbol DMRS), the DCI is used to specify a configuration of time spread with a length of 2 in addition to the above.

The Sounding Reference Signal (SRS) is not associated with the transmission of the physical uplink shared channel/the physical uplink control channel. In other words, with or without uplink data transmission, the terminal apparatus transmits the SRS periodically or aperiodically. For the periodic SRS, the terminal apparatus transmits the SRS, based on a parameter notified via the higher layer signal (e.g., the RRC) from the base station apparatus. On the other hand, for the aperiodic SRS, the terminal apparatus transmits the SRS, based on a physical downlink control channel (for example, the DCI) indicating a parameter notified via the higher layer signal (e.g., the RRC) from the base station apparatus and a transmission timing for the SRS. The base station apparatus 10 uses the SRS to measure an uplink channel state (CSI Measurement). The base station apparatus 10 may perform timing alignment and closed loop transmission power control, based on the measurement results obtained by the reception of the SRS.

In FIG. 1, at least the following downlink physical channels are used in radio communication of the downlink r31. The downlink physical channels are used for transmitting information output from the higher layer.
Physical Broadcast Channel (PBCH)
Physical Downlink Control Channel (PDCCH)
Physical Downlink Shared Channel (PDSCH)

The PBCH is used for broadcasting a Master Information Block (MIB, a Broadcast CHannel (BCH)) that is used commonly by the terminal apparatuses. The MIB is one of pieces of system information. For example, the MIB includes a downlink transmission bandwidth configuration and a System Frame Number (SFN). The MIB may include information indicating at least some of numbers of a slot, a subframe, and a radio frame in which a PBCH is transmitted.

The PDCCH is used to transmit downlink control information (DCI). For the downlink control information, multiple formats based on applications (also referred to as DCI formats) are defined. The DCI format may be defined based on the type and the number of bits of the DCI constituting a single DCI format. The downlink control information includes control information for downlink data transmission and control information for uplink data transmission. The DCI format for downlink data transmission is also referred to as downlink assignment (or downlink grant (DL Grant)). The DCI format for uplink data transmission is also referred to as uplink grant (or uplink assignment or UL Grant).

The DCI format for downlink data transmission includes DCI format 1_0 and DCI format 1_1. DCI format 1_0 is used for downlink data transmission for fallback, and has fewer configurable parameters (fields) than DCI format 1_1 supporting MIMO and the like. Additionally, DCI format 1_1 allows switching between the presence and absence (active/inactive) of a parameter (field) to be notified, and includes more bits than DCI format 1_0 depending on activated fields. On the other hand, DCI format 1_1 allows notification of MIMO and multiple codeword transmissions, a ZP CSI-RS trigger, CBG transmission information, and the like, and the presence or absence of some fields and the number of bits are added to DCI format 1_1 in accordance with the configuration provided in the higher layer (e.g., RRC signaling or MAC CE). A single downlink assignment is used for scheduling a single PDSCH in a single serving cell. A configured BWP is used for scheduling a single PDSCH in an active BWP within a single serving cell. The downlink grant may be used at least for scheduling the PDSCH within the same slot/subframe as that in which the downlink grant has been transmitted. The downlink grant may be used for scheduling the PDSCH located K₀ slots/subframes after the slot/subframe in which the downlink grant has been transmitted. The downlink grant may be used for scheduling the PDSCH in multiple slots/subframes. The downlink assignment using DCI format 1_0 includes the following fields. For example, the fields include a DCI format identifier, frequency domain resource assignment (resource block allocation for the PDSCH, resource allocation), time domain resource assignment, VRB to PRB mapping, a Modulation and Coding Scheme (MCS) for the PDSCH (information indicating modulation order and coding rate), a NEW Data Indicator (NDI) indicating an initial transmission or retransmission, information indicating the HARQ process number in the downlink, a Redundancy version (RV) indicating the information of the redundancy bits added to the codeword during error correction coding, a Downlink Assignment Index (DAI), a Transmission Power Control (TPC) command for the PUCCH, a resource indicator for the PUCCH, an indicator for a timing for HARQ feedback from the PDSCH, and the like. Note that the DCI format for each downlink data transmission may include one or more required pieces of information (fields) corresponding to any of the above-described pieces of information. One or both of DCI format 1_0 and DCI format 1_1 may be used for activation and deactivation (release) of the downlink SPS. DCI format 1_1 may indicate the switching of an Active BWP in a case that multiple BWPs are configured. Here, it is assumed that a single BWP is active within a single serving cell.

The DCI format for uplink data transmission includes DCI format 0_0 and DCI format 0_1. DCI format 0_0 is used for uplink data transmission for fallback, and has fewer configurable parameters (fields) than DCI format 0_1 supporting MIMO and the like. Additionally, DCI format 0_1 allows switching between the presence and absence (active/inactive) of a parameter (field) to be notified, and includes more bits than DCI format 0_0 depending on activated fields. On the other hand, DCI format 0_1 allows notification of MIMO and multiple codeword transmissions, an SRS resource indicator, precoding information, antenna port information, SRS request information, CSI request information, CBG transmission information, uplink PTRS association, sequence initialization for the DMRS, and the like, and the presence or absence of some fields and the number of bits are added to DCI format 0_1 in accordance with the configuration provided in the higher layer (e.g., RRC signaling). A single uplink grant is used for notifying the terminal apparatus of scheduling of a single PUSCH in a single serving cell. A configured BWP is used for scheduling a single PUSCH in an active BWP within a single serving cell. The uplink grant may be used for scheduling of the PUSCH located K₂ slots/subframes after the slot/subframe in which the uplink grant has been transmitted. Additionally, the uplink grant may be used for scheduling the PUSCH in multiple slots/subframes. The uplink grant using DCI format 0_0 includes the following fields. For example, the fields include a DCI format identifier, frequency domain resource assignment (information related to resource block assignment for transmission of the PUSCH, and time domain resource assignment, a frequency hopping flag, information related to MCS of the PUSCH, the RV, NDI, information indicating the HARQ process number in the uplink, the TPC command for the PUSCH, the UL/Supplemental UL (SUL) indicator, and the like. One or both of DCI format 0_0 and DCI format 0_1 may be used for activation and deactivation (release) of the uplink SPS. DCI format 1_0 may indicate switching of an Active BWP in a case that multiple BWPs are configured. Here, it is assumed that a single BWP is active within a single serving cell.

The DCI format may be DCI format 2_0 in which the CRC is scrambled with SFI-RNTI and which may be used for notification of the slot format indicator (SFI). The DCI format may be DCI format 2_1 in which the CRC is scrambled with INT-RNTI and which may be used for notification of the PRB (one or more) and the OFDM symbol (one or more) that may be assumed by the terminal apparatus to lack downlink data transmission intended for the terminal apparatus. The DCI format may be DCI format 2_2 in which the CRC is scrambled with TPC-PUSCH-RNTI or TPC-PUCCH-RNTI and which may be used for transmission of the TPC command for the PUSCH and the PUCCH. The DCI format may be DCI format 2_3 in which the CRC is scrambled with TPC-SRS-RNTI and which may be used to transmit a group of TPC commands for SRS transmission by one or more terminal apparatuses. DCI format 2_3 may also be used for an SRS request. The DCI format may be DCI format 2_X (for example, DCI format 2_4 or DCI format 2_1A) in which the CRC is scrambled with INT-RNTI or other RNTI (e.g., UL-INT-RNTI) and which may be used for notification of the PRB (1 or more) and the OFDM symbol (1 or more) in which the terminal apparatus does not perform data transmission, the PRB and OFDM symbol being included in those which are already scheduled based on UL Grant/Configured UL Grant.

The MCS for the PDSCH/PUSCH may use an index (MCS index) indicating the modulation order of the PDSCH/the PUSCH and the coding rate for the target. The modulation order is associated with a modulation scheme. Modulation orders “2,” “4,” and “6” respectively indicate “QPSK,” “16QAM,” and “64QAM.” Furthermore, in a case that 256QAM or 1024QAM is configured in the higher layer (e.g., RRC signaling), the modulation order “8” indicating “256QAM” or “10” indicating “1024QAM.” The target coding rate is used to determine a transport block size (TBS) indicating the number of bits to be transmitted, depending on the number of resource elements (number of resource blocks) for the PDSCH/PUSCH scheduled in the PDCCH. The communication system 1 (base station apparatus 10 and terminal apparatus 20) shares the method of calculating the transport block size, based on the MCS, the coding rate for the target, and the number of resource elements allocated for the PDSCH/PUSCH transmission (number of resource blocks).

The PDCCH is generated by adding a Cyclic Redundancy Check (CRC) to the downlink control information. In the PDCCH, CRC parity bits are scrambled with a prescribed identifier (also referred to as an exclusive OR operation, mask). The parity bits are scrambled with a Cell-Radio Network Temporary Identifier (C-RNTI), a Configured Scheduling (CS)-RNTI, a Temporary C (TC)-RNTI, a Paging (P)-RNTI, a System Information (SI)-RNTI, a Random Access (RA)-RNTI, an INT-RNTI, a Slot Format Indicator (SFI)-RNTI, a TPC-PUSCH-RNTI, a TPC-PUCCH-RNTI, or a TPC-SRS-RNTI. The C-RNTI is an identifier for identifying dynamic scheduling, and the CS-RNTI is an identifier for identifying a terminal apparatus in the cell, based on SPS/grant free access/Configured Grant Type1 or Type2. The Temporary C-RNTI is an identifier for identifying the terminal apparatus that has transmitted a random access preamble in a contention based random access procedure. The C-RNTI and the Temporary C-RNTI are used to control PDSCH transmission or PUSCH transmission in a single subframe. The CS-RNTI is used to periodically allocate a resource for the PDSCH or the PUSCH. The P-RNTI is used to transmit a paging message (Paging Channel (PCH)). The SI-RNTI is used to transmit the SIB, and the RA-RNTI is used to transmit a random access response (a message 2 in a random access procedure). The SFI-RNTI is used to notify the slot format. The INT-RNTI is used to notify downlink/uplink Pre-emption. The TPC-PUSCH-RNTI, the TPC-PUCCH-RNTI, and the TPC-SRS-RNTI are used to notify the respective transmit power control values for the PUSCH, the PUCCH, and the SRS. Note that, for multiple configurations of grant free access/SPS/Configured Grant Type1 or Type2, the identifier may include a CS-RNTI for each of the configurations. As an example, the DCI to which the CRC scrambled with the CS-RNTI is added can be used for activation and deactivation (release) of grant free access, parameter changes, and retransmission control (ACK/NACK transmission), and the parameters may include resource configurations (a DMRS configuration parameter, frequency domain and time domain resources for grant free access, the MCS used for grant free access, the number of repetitions, the presence of frequency hopping, etc.).

The PDSCH is used to transmit the downlink data (the downlink transport block, DL-SCH). The PDSCH is used to transmit a system information message (also referred to as a System Information Block (SIB)). Some or all of the SIBs can be included in the RRC message.

The PDSCH is used to transmit the RRC signaling. The RRC signaling transmitted from the base station apparatus may be common to the multiple terminal apparatuses in the cell (unique to the cell). That is, the information common to the user equipments in the cell is transmitted using the RRC signaling unique to the cell. The RRC signaling transmitted from the base station apparatus may be a message dedicated to a certain terminal apparatus (also referred to as dedicated signaling). In other words, user equipment specific (UE-Specific) information is transmitted by using the message dedicated to the certain terminal apparatus.

The PDSCH is used to transmit the MAC CE. The RRC signaling and/or the MAC CE is also referred to as a higher layer signal (higher layer signaling). The PMCH is used to transmit multicast data (Multicast Channel (MCH)).

In the downlink radio communication in FIG. 1, a Synchronization signal (SS) and a Downlink Reference Signal (DL RS) are used as downlink physical signals.

The synchronization signal is used for the terminal apparatus to take synchronization in the frequency domain and the time domain in the downlink. The downlink reference signal is used for the terminal apparatus to perform the channel estimation/channel compensation on the downlink physical channel. For example, the downlink reference signal is used to demodulate the PBCH, the PDSCH, and the PDCCH. The downlink reference signal can be used for the terminal apparatus to measure the downlink channel state (CSI measurement). The downlink reference signal may include a Cell-specific Reference Signal (CRS), a Channel state information Reference Signal (CSI-RS), a Discovery Reference Signal (DRS), and a Demodulation Reference Signal (DMRS).

The downlink physical channel and the downlink physical signal are also collectively referred to as a downlink signal. The uplink physical channel and the uplink physical signal are also collectively referred to as an uplink signal. The downlink physical channel and the uplink physical channel are also collectively referred to as a physical channel. The downlink physical signal and the uplink physical signal are also collectively referred to as a physical signal.

The BCH, the UL-SCH, and the DL-SCH are transport channels. Channels used in the Medium Access Control (MAC) layer are referred to as transport channels. A unit of the transport channel used in the MAC layer is also referred to as a Transport Block (TB) or a MAC Protocol Data Unit (PDU). The transport block is a unit of data that the MAC layer delivers to the physical layer. In the physical layer, the transport block is mapped to a codeword, and coding processing and the like are performed for each codeword.

The higher layer processing includes processing in a Medium Access Control (MAC) layer, a Packet Data Convergence Protocol (PDCP) layer, a Radio Link Control (RLC) layer, a Radio Resource Control (RRC) layer, and the like, which are higher than the physical layer.

Processing is performed in the Medium Access Control (MAC) layer, the Packet Data Convergence Protocol (PDCP) layer, the Radio Link Control (RLC) layer, the Radio Resource Control (RRC) layer, and the like, which are higher than the physical layer.

The higher layer processing unit configures various RNTIs for each terminal apparatus. The RNTI is used for encryption (scrambling) of the PDCCH, the PDSCH, and the like. The higher layer processing includes generating, or acquiring from higher nodes, the downlink data (transport blocks, DL-SCH) allocated to the PDSCH, system information specific to the terminal apparatus (System Information Blocks (SIBs)), the RRC message, the MAC CE, and the like, for transmission. The higher layer processing includes managing various kinds of configuration information of the terminal apparatus 20. Note that a part of the function of the radio resource control may be performed in the MAC layer or the physical layer.

The higher layer processing includes receiving information related to the terminal apparatus, such as functions supported by the terminal apparatus (UE capabilities), from the terminal apparatus 20. The terminal apparatus 20 transmits its own function to the base station apparatus 10 by a higher layer signaling (RRC signaling). The information on the terminal apparatus includes information for indicating whether the terminal apparatus supports a prescribed function or information for indicating that the terminal apparatus has completed introduction and testing of the prescribed function. The information for indicating whether the prescribed function is supported includes information for indicating whether the introduction and testing of the prescribed function have been completed.

In a case that the terminal apparatus supports the prescribed function, the terminal apparatus transmits information (parameters) for indicating whether the prescribed function is supported. In a case that the terminal apparatus does not support a prescribed function, the terminal apparatus need not transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

In FIG. 1, the base station apparatus 10 and the terminal apparatuses 20 support, in the uplink, Multiple Access (MA) using grant free access (also referred to as grant less access, Contention-based access, Autonomous access, Resource allocation for uplink transmission without grant, configured grant type1 transmission, or the like, hereinafter referred to as grant free access). Grant free access refers to a scheme in which the terminal apparatus transmits uplink data (such as a physical uplink channel) without execution of a procedure for specifying physical resources or transmission timings for SR transmission by the terminal apparatus and data transmission by the base station apparatus based on the UL Grant using the DCI (also referred to as UL Grant through L1 signaling). Thus, through RRC signaling (e.g., ConfiguredGrantConfig), the terminal apparatus preliminarily receives, as Configured Uplink Grant (rrcConfiguredUplinkGrant configured uplink grant) for the RRC signaling, physical resources that can be used for grant free access (frequency domain resource assignment and time domain resource assignment) and transmission parameters (which may include a cyclic shift for the DMRS, an OCC, an antenna port number, the positions and number of OFDM symbols in which the DMRS is allocated, the number of repeated transmissions of the same transport, and the like), in addition to the allocation period of resources available, target received power, the value (α) of a fractional TPC, the number of HARQ processes, and an RV pattern during repeated transmission of the same transport. Then, the terminal apparatus can perform data transmission using the configured physical resources only in a case that the transmission data is in the buffer. In other words, in a case that the higher layer carries no transport blocks transmitted through grant free access, data transmission through grant free access is not performed. Additionally, in a case that the terminal apparatus has received ConfiguredGrantConfig but not rrc-ConfiguredUplinkGrant for the RRC signaling, the terminal apparatus can perform similar data transmission through SPS (configured grant type2 transmission) by activation based on the UL Grant (DCI format).

The following two types of grant free access are available. A first configured grant type1 transmission (UL-TWG-type1) is a scheme in which the base station apparatus transmits transmission parameters related to grant free access to the terminal apparatus through higher layer signaling (e.g., RRC) and further transmits the start (activation or RRC setup) and end (deactivation (release) or RRC release) of grant of data transmission through grant free access, and changes in transmission parameters through higher layer signaling. Here, the transmission parameters related to grant free access may include physical resources available for data transmission through grant free access (resource assignments in time domain and frequency domain), the periodicity of the physical resources, the MCS, the presence of repeated transmissions, the number of repetitions, the configuration of the RV for repeated transmissions, the presence of frequency hopping, a hopping pattern, configurations for the DMRS (such as configurations of the number of OFDM symbols, the cyclic shift, and the time spread for the front-loaded DMRS, and the like), the number of HARQ processes, information of a transformer precoder, and information regarding configurations related to TPC. The transmission parameters related to grant free access and the start of grant of data transmission may be simultaneously configured, or, after the transmission parameters related to grant free access are configured, the start of grant of data transmission through grant free access may be configured at a different timing (for the SCell, through SCell activation or the like). In a second configured grant type2 transmission (UL-TWG-type2), the base station apparatus uses higher layer information (e.g., an RRC message) to transmit the transmission parameters related to grant free access to the terminal apparatus, and uses the DCI (L1 signaling) to transmit the start (activation) and end (deactivation (release)) of grant of data transmission through grant free access, and changes in transmission parameters. Here, the RRC may include the periodicity of physical resources, the number of repetitions, the configuration of the RV for repeated transmission, the number of HARQ processes, the information of the transformer precoder, and the configurations related to TPC, and the start of grant (activation) using the DCI may include the physical resources available for grant free access (allocation of resource blocks). The transmission parameters related to grant free access and the start of grant of data transmission may be simultaneously configured, or after the transmission parameters related to grant free access are configured, the start of grant of data transmission through grant free access data transmission may be configured at a different timing. The present invention may be applied to any of the types of grant free access described above.

On the other hand, a Semi-Persistent Scheduling (SPS) technology has been introduced into LTE, which enables periodic resource allocation for applications such as VOID (Voice over Internet Protocol). The SPS uses the DCI, and the grant is started (activation) using prescribed DCI including specification of physical resources (allocation of resource blocks) and transmission parameters for the MCS and the like. Thus, the type of grant free access (UL-TWG-type1) corresponding to the start of grant (activation) using higher layer information (e.g., an RRC message) uses an initiating procedure different from the initiating procedure for the SPS. In addition, UL-TWG-type2 may be the same as the SPS in the start of grant (activation) using the DCI (L1 signaling) but may be different from the SPS in usability for the SCell, the BWP, and the SUL, and notification of the number of repetitions and the configuration of the RV for repeated transmissions in RRC signaling. Additionally, the base station apparatus may perform scrambling by using different types of RNTIs for the DCI (L1 signaling) used for grant free access (retransmission of UL-TWG-type1 or configuration and retransmission of UL-TWG-type2) and for the DCI used for dynamic scheduling, or the same RNTI (CS-RNTI) may be used for the DCI used for retransmission control for UL-TWG-type1 and for the DCI used for activation and deactivation (release) of and retransmission control for UL-TWG-type2.

The base station apparatus 10 and the terminal apparatus 20 may support non-orthogonal multi-access in addition to orthogonal multi-access. Note that the base station apparatus 10 and the terminal apparatus 20 can support both the grant free access and scheduled access (dynamic scheduling). Here, the uplink scheduled access refers to the terminal apparatus 20 transmitting data according to the following procedure. The terminal apparatus 20 uses a Random Access Procedure or the SR to request, from the base station apparatus 10, radio resources used to transmit uplink data. The base station apparatus uses the DCI to provide UL Grant to each terminal apparatus, based on the RACH or SR. In a case of receiving the UL Grant for control information from the base station apparatus, the terminal apparatus transmits uplink data using a prescribed radio resource, based on the uplink transmission parameter included in the UL Grant.

The downlink control information for physical channel transmission in the uplink may include a shared field shared between the scheduled access and the grant free access. In this case, in a case that the base station apparatus 10 indicates transmission of the uplink physical channel using the grant free access, the base station apparatus 10 and the terminal apparatus 20 interpret a bit sequence stored in the shared field in accordance with a configuration for the grant free access (e.g., a look-up table defined for the grant free access). Similarly, in a case that the base station apparatus 10 indicates transmission of the uplink physical channel using the scheduled access, the base station apparatus 10 and the terminal apparatus 20 interpret the shared field in accordance with a configuration for the scheduled access. Transmission of the uplink physical channel in the grant free access is referred to as Asynchronous data transmission. Note that the transmission of the uplink physical channel in the scheduled is referred to as Synchronous data transmission.

In the grant free access, the terminal apparatus 20 may randomly select a radio resource for transmission of uplink data. For example, the terminal apparatus 20 has been notified, by the base station apparatus 10, of multiple candidates for available radio resources as a resource pool, and randomly selects a radio resource from the resource pool. In the grant free access, the radio resource in which the terminal apparatus 20 transmits the uplink data may be configured in advance by the base station apparatus 10. In this case, the terminal apparatus 20 transmits the uplink data using the radio resource configured in advance without receiving the UL Grant (including the specification of the physical resource) of the DCI. The radio resource includes multiple uplink multi-access resources (resources to which the uplink data can be mapped). The terminal apparatus 20 transmits the uplink data by using one or more uplink multi-access resources selected from the multiple uplink multi-access resources. Note that the radio resource in which the terminal apparatus 20 transmits the uplink data may be predetermined in the communication system including the base station apparatus 10 and the terminal apparatus 20. The radio resource for transmission of the uplink data may be notified to the terminal apparatus 20 by the base station apparatus 10 using a physical broadcast channel (e.g., Physical Broadcast Channel (PBCH)/Radio Resource Control (RRC)/system information (e.g., System Information Block (SIB)/physical downlink control channel (downlink control information, e.g., Physical Downlink Control Channel (PDCCH), Enhanced PDCCH (EPDCCH), MTC PDCCH (MPDCCH), Narrowband PDCCH (NPDCCH), or New Radio PDCCH (NRPDCCH)).

In the grant free access, the uplink multi-access resource includes a multi-access physical resource and a Multi-Access Signature Resource. The multi-access physical resource is a resource including time and frequency. The multi-access physical resource and the multi-access signature resource may be used to identify the uplink physical channel transmitted by each terminal apparatus. The resource blocks are units to which the base station apparatus 10 and the terminal apparatus 20 are capable of mapping the physical channel (e.g., the physical data shared channel or the physical control channel). Each of the resource blocks includes one or more subcarriers (e.g., 12 subcarriers or 16 subcarriers) in a frequency domain.

The multi-access signature resource includes at least one multi-access signature of multiple multi-access signature groups (also referred to as multi-access signature pools). The multi-access signature is information indicating a characteristic (mark or indicator) that distinguishes (identifies) the uplink physical channel transmitted by each terminal apparatus. Examples of the multi-access signature include a spatial multiplexing pattern, a spreading code pattern (a Walsh code, an Orthogonal Cover Code (OCC), a cyclic shift for data spreading, the sparse code, or the like), an interleaving pattern, a demodulation reference signal pattern (a reference signal sequence, the cyclic shift, the OCC, or IFDM)/an identification signal pattern, and transmit power, at least one of which is included in the multi-access signature. In the grant free access, the terminal apparatus 20 transmits the uplink data by using one or more multi-access signatures selected from the multi-access signature pool. The terminal apparatus 20 can notify the base station apparatus 10 of available multi-access signatures. The base station apparatus 10 can notify the terminal apparatus of a multi-access signature used by the terminal apparatus 20 to transmit the uplink data. The base station apparatus 10 can notify the terminal apparatus 20 of an available multi-access signature group by the terminal apparatus 20 to transmit the uplink data. The available multi-access signature group may be notified by using the broadcast channel/RRC/system information/downlink control channel. In this case, the terminal apparatus 20 can transmit the uplink data by using a multi-access signature selected from the notified multi-access signature group.

The terminal apparatus 20 transmits the uplink data by using a multi-access resource. For example, the terminal apparatus 20 can map the uplink data to a multi-access resource including a multi-carrier signature resource including one multi-access physical resource, a spreading code pattern, and the like. The terminal apparatus 20 can allocate the uplink data to a multi-access resource including a multi-carrier signature resource including one multi-access physical resource and an interleaving pattern. The terminal apparatus 20 can also map the uplink data to a multi-access resource including a multi-access signature resource including one multi-access physical resource and a demodulation reference signal pattern/identification signal pattern. The terminal apparatus 20 can also map the uplink data to a multi-access resource including one multi-access physical resource and a multi-access signature resource including a transmit power pattern (e.g., the transmit power for each of the uplink data may be configured to cause a difference in receive power at the base station apparatus 10). In such a grant free access, the communication system of the present embodiment may allow uplink data transmitted by the multiple terminal apparatuses 20 to be transmitted while overlapping one another (being superimposed on one another, being spatially multiplexed with one another, being non-orthogonally multiplexed with one another, or colliding with one another) in the uplink multi-access physical resource.

The base station apparatus 10 detects, in the grant free access, a signal of the uplink data transmitted by each terminal apparatus. To detect the uplink data signal, the base station apparatus 10 may include Symbol Level Interference Cancellation (SLIC) in which interference is canceled based on a demodulation result for an interference signal, Codeword Level Interference Cancellation (CWIC, also referred to as Sequential Interference Canceler (SIC) or Parallel Interference Canceler (PIC)) in which interference is canceled based on the decoding result for the interference signal, turbo equalization, maximum likelihood detection (MLD, Reduced complexity maximum likelihood detection (R-MLD)) in which transmit signal candidates are searched for the most probable signal, Enhanced Minimum Mean Square Error-Interference Rejection Combining (EMMSE-IRC) in which interference signals are suppressed by linear computation, signal detection based on message passing (Belief propagation (BP), Matched Filter (MF)-BP in which a matched filter is combined with BP, or the like.

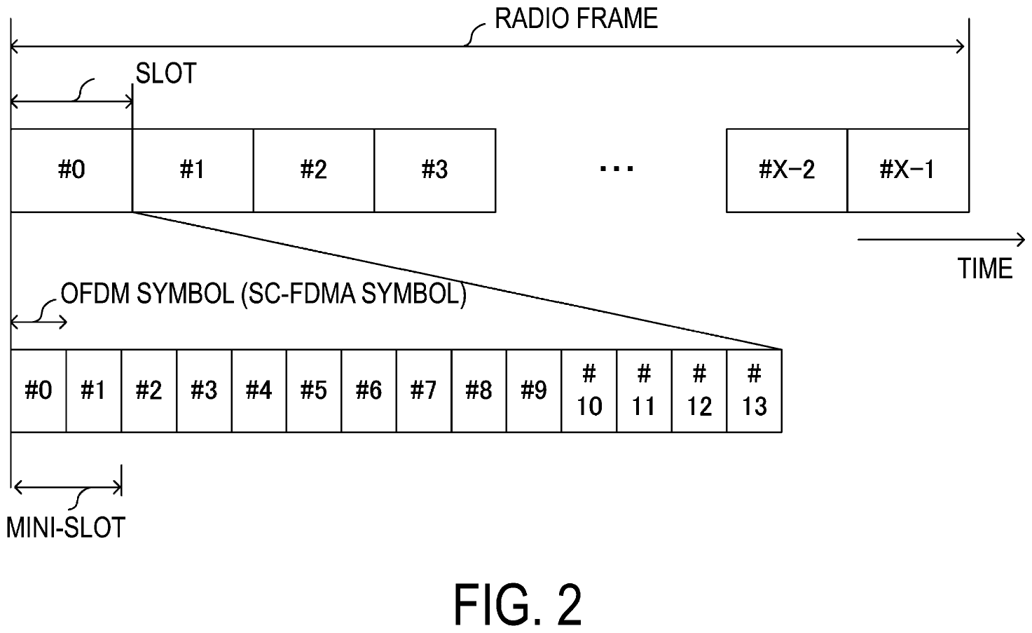

FIG. 2 is a diagram illustrating an example of a radio frame structure for a communication system according to the present embodiment. The radio frame structure indicates a configuration of multi-access physical resources in a time domain. One radio frame includes multiple slots (or subframes). FIG. 2 is an example in which one radio frame includes 10 slots. The terminal apparatus 20 has a subcarrier spacing used as a reference (reference numerology). The subframe includes multiple OFDM symbols generated at the subcarrier spacings used as the reference. FIG. 2 is an example in which the subcarrier spacing is 15 kHz, one frame includes 10 slots, one subframe includes one slot, and one slot includes 14 OFDM symbols. At subcarrier spacings of 15 kHz×2μ (μ is an integer of 0 or greater), one frame includes 2μ×10 slots and one subframe includes 2μ slots.

FIG. 2 illustrates a case where the subcarrier spacing used as the reference is the same as a subcarrier spacing used for the uplink data transmission. The communication system according to the present embodiment may use slots as minimum units to which the terminal apparatus 20 maps the physical channel (e.g., the physical data shared channel or the physical control channel). In this case, in the multi-access physical resource, one slot is defined as a resource block unit in the time domain. Furthermore, in the communication system according to the present embodiment, the minimum unit in which the terminal apparatus 20 maps the physical channel may be one or multiple OFDM symbols (e.g., 2 to 13 OFDM symbols). For the base station apparatus 10, one or multiple OFDM symbols are used as a resource block unit in the time domain. The base station apparatus 10 may signal, to the terminal apparatus 20, the minimum unit for mapping of the physical channel.

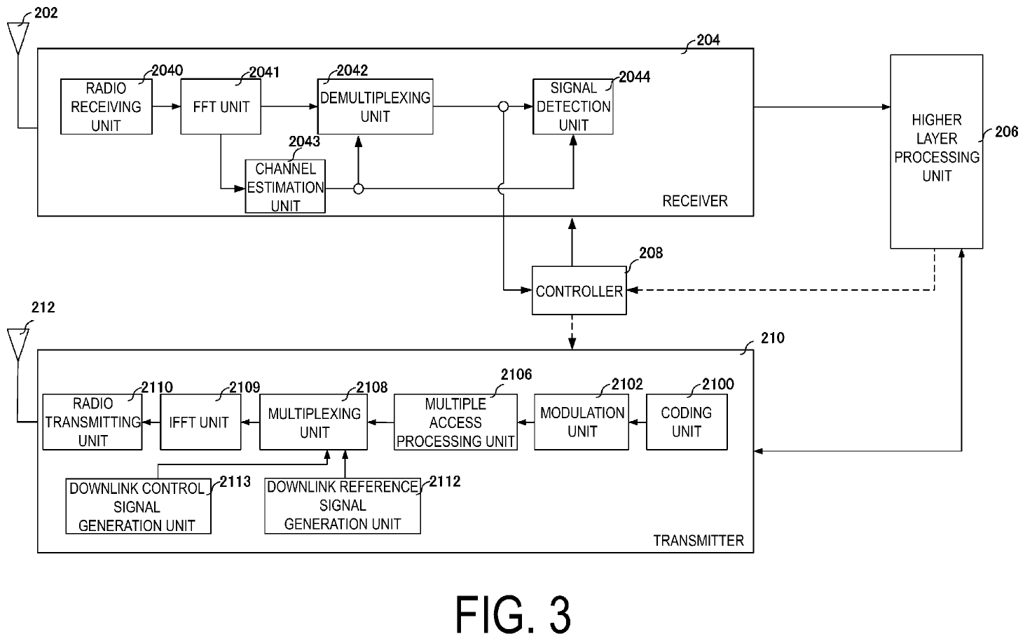

FIG. 3 is a schematic block diagram illustrating a configuration of the base station apparatus 10 according to the present embodiment. The base station apparatus 10 includes a receive antenna 202, a receiver (receiving step) 204, a higher layer processing unit (higher layer processing step) 206, a controller (control step) 208, a transmitter (transmitting step) 210, and a transmit antenna 212. The receiver 204 includes a radio receiving unit (radio receiving step) 2040, an FFT unit 2041 (FFT step), a demultiplexing unit (demultiplexing step) 2042, a channel estimation unit (channel estimation step) 2043, and a signal detection unit (signal detection step) 2044. The transmitter 210 includes a coding unit (coding step) 2100, a modulation unit (modulation step) 2102, a multiple-access processing unit (multiple-access processing step) 2106, a multiplexing unit (multiplexing step) 2108, a radio transmitting unit (radio transmitting step) 2110, a IFFT unit (IFFT step) 2109, a downlink reference signal generation unit (downlink reference signal generation step) 2112, and a downlink control signal generation unit (downlink control signal generation step) 2113.

The receiver 204 demultiplexes, demodulates, and decodes an uplink signal (uplink physical channel or uplink physical signal) received from the terminal apparatus 10 via the receive antenna 202. The receiver 204 outputs a control channel (control information) separated from the received signal to the controller 208. The receiver 204 outputs a decoding result to the higher layer processing unit 206. The receiver 204 acquires the SR included in the received signal and the ACK/NACK and CSI for downlink data transmission.

The radio receiving unit 2040 converts the uplink signal received through the receive antenna 202 into a baseband signal by down-conversion, removes unnecessary frequency components from the baseband signal, controls an amplification level such that a signal level is suitably maintained, performs orthogonal demodulation, based on an in-phase component and an orthogonal component of the received signal, and converts the resulting orthogonally-demodulated analog signal into a digital signal. The radio receiving unit 2040 removes a portion of the digital signal resulting from the conversion, the portion corresponding to a Cyclic Prefix (CP). The FFT unit 2041 performs a fast Fourier transform on the downlink signal from which CP has been removed (demodulation processing for OFDM modulation), and extracts the signal in the frequency domain.

The channel estimation unit 2043 uses the demodulation reference signal to perform channel estimation for signal detection for the uplink physical channel. The channel estimation unit 2043 receives, as inputs, from the controller 208, the resources to which the demodulation reference signal is mapped and the demodulation reference signal sequence allocated to each terminal apparatus. The channel estimation unit 2043 uses the demodulation reference signal sequence to measure the channel state between the base station apparatus 10 and the terminal apparatus 20. In a case of grant free access, the channel estimation unit 2043 can identify the terminal apparatus by using the result of channel estimation (impulse response and frequency response with the channel state) (the channel estimation unit 2043 is thus also referred to as an identification unit). The channel estimation unit 2043 determines that an uplink physical channel has been transmitted by the terminal apparatus 20 associated with the demodulation reference signal from which the channel state has been successfully extracted. In the resource on which the uplink physical channel is determined by the channel estimation unit 2043 to have been transmitted, the demultiplexing unit 2042 extracts the frequency domain signal input from the FFT unit 2041 (the signal includes signals from multiple terminal apparatuses 20).

The demultiplexing unit 2042 separates and extracts an uplink physical channel included in the frequency domain uplink physical channel extracted (physical uplink control channel or physical uplink shared channel) or the like. The demultiplexing unit outputs the physical uplink channel to the signal detection unit 2044/controller 208.

The signal detection unit 2044 uses the channel estimation result of the estimation in the channel estimation unit 2043 and the frequency domain signal input from the demultiplexing unit 2042 to detect a signal of uplink data (uplink physical channel) from each terminal apparatus. The signal detection unit 2044 performs detection processing for a signal from the terminal apparatus 20 associated with the demodulation reference signal (demodulation reference signal from which the channel state has been successfully extracted) allocated to the terminal apparatus 20 determined to have transmitted the uplink data.

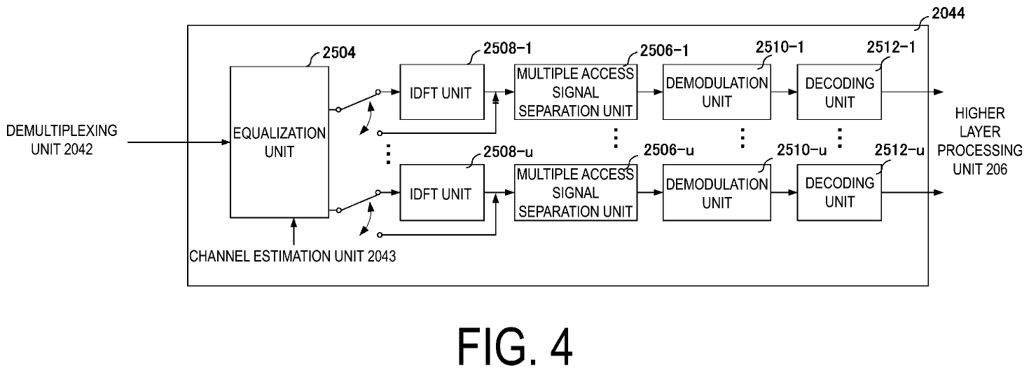

FIG. 4 is a diagram illustrating an example of the signal detection unit according to the present embodiment. The signal detection unit 2044 includes an equalization unit 2504, multiple-access signal separation units 2506-1 to 2506-u, IDFT units 2508-1 to 2508-u, demodulation units 2510-1 to 2510-u, and decoding units 2512-1 to 2512-u. u is, in a case of grant free access, the number of terminal apparatuses determined by the channel estimation unit 2043 to have transmitted uplink data (for which the channel state has been successfully extracted) on the same multi-access physical resource or overlapping multi-access physical resources (at the same time and at the same frequency). u is, in a case of scheduled access, the number of terminal apparatuses that allow uplink data transmission in the same multi-access physical resource or overlapping multi-access physical resources by using the DCI (at the same time, for example, OFDM symbols, slots). Each of the units of the signal detection unit 2044 is controlled by using the configuration related to grant free access for each terminal apparatus and input from the controller 208.

The equalization unit 2504 generates an equalization weight based on the MMSE standard, from the frequency response input from the channel estimation unit 2043. Here, MRC and ZF may be used for the equalization processing. The equalization unit 2504 multiplies the equalization weight by the frequency domain signal (including the signal from each terminal apparatus) input from the demultiplexing unit 2042, and extracts the frequency domain signal from each terminal apparatus. The equalization unit 2504 outputs the equalized frequency domain signal from each terminal apparatus to the IDFT units 2508-1 to 2508-u. Here, in a case that data is to be detected that is transmitted by the terminal apparatus 20 and that uses a DFTS-OFDM signal waveform, the frequency domain signal is output to the IDFT units 2508-1 to 2508-u. In a case that data is to be received that is transmitted by the terminal apparatus 20 and that uses the OFDM signal waveform, the frequency domain signal is output to the multiple-access signal separation units 2506-1 to 2506-u.

The IDFT units 2508-1 to 2508-u converts the equalized frequency domain signal from each terminal apparatus into a time domain signal. Note that the IDFT units 2508-1 to 2508-u correspond to processing performed by the DFT unit of the terminal apparatus 20. The multiple-access signal separation units 2506-1 to 2506-u separates the signal multiplexed by the multi-access signature resource from the time domain signal from each terminal apparatus after conversion with the IDFT (multiple-access signal separation processing). For example, in a case that code spreading is used as a multi-access signature resource, each of the multiple-access signal separation units 2506-1 to 2506-u performs inverse spreading processing using the spreading code sequence assigned to each terminal apparatus. Note that, in a case that interleaving is applied as a multi-access signature resource, de-interleaving is performed on the signal in the time domain from each terminal apparatus after conversion with the IDFT (deinterleaving unit).

The demodulation units 2510-1 to 2510-u receive, as an input from the controller 208, pre-notified or predetermined information about the modulation scheme (BPSK, QPSK, 16QAM, 64QAM, 256QAM, or the like) for each terminal apparatus. Based on the information about the modulation scheme, the demodulation units 2510-1 to 2510-u perform demodulation processing on the separated multiple-access signal, and outputs a Log Likelihood Ratio (LLR) of the bit sequence.

The decoding units 2512-1 to 2512-u receives, as an input from the controller 208, pre-notified or predetermined information about the coding rate. The decoding units 2512-1 to 2512-u perform decoding processing on the LLR sequences output from the demodulation units 2510-1 to 2510-u, and output, to the higher layer processing unit 206, uplink data/uplink control information resulting from decoding. In order to perform cancellation processing such as a Successive Interference Canceller (SIC) or turbo equalization, the decoding units 2512-1 to 2512-u generate a replica from external LLRs or post LLRs output from the decoding units and perform the cancellation processing. A difference between the external LLR and the post LLR is whether to subtract, from the decoded LLR, the pre LLR input to each of the decoding units 2512-1 to 2512-u or not. In a case that the number of repetitions of SIC or turbo equalization is larger than or equal to a prescribed value, the decoding units 2512-1 to 2512-u may perform hard decision on the LLR resulting from the decoding processing and output the bit sequence of the uplink data for each terminal apparatus to the higher layer processing unit 206. Note that the present invention is not limited to signal detection using the turbo equalization processing, which can be replaced with signal detection based on replica generation and using no interference cancellation, maximum likelihood detection, EMMSE-IRC, or the like.

The controller 208 controls the receiver 204 and the transmitter 210 by using the configuration information related to the uplink reception/configuration information (notified from the base station apparatus to the terminal apparatus using the DCI or using the RRC, the SIB, or the like) related to the downlink transmission included in the uplink physical channel (physical uplink control channel, physical uplink shared channel, or the like). The controller 208 acquires the configuration information related to the uplink reception and/or the configuration information related to the downlink transmission from the higher layer processing unit 206. In a case that the transmitter 210 transmits the physical downlink control channel, the controller 208 generates Downlink Control information (DCI) and outputs the resultant information to the transmitter 210. Note that some of the functions of the controller 108 can be included in the higher layer processing unit 102. Note that the controller 208 may control the transmitter 210 in accordance with the parameter of the CP length added to the data signal.

The higher layer processing unit 206 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 206 generates information needed to control the transmitter 210 and the receiver 204, and outputs the resultant information to the controller 208. The higher layer processing unit 206 outputs downlink data (e.g., the DL-SCH), broadcast information (e.g., the BCH), a Hybrid Automatic Repeat request indicator (HARQ indicator), and the like to the transmitter 210. The higher layer processing unit 206 receives, as an input from the receiver 204, information related to a function of the terminal apparatus (UE capability) supported by the terminal apparatus itself. For example, the higher layer processing unit 206 receives, through RRC layer signaling, information related to the function of the terminal apparatus.

The information related to the function of the terminal apparatus includes information indicating whether the terminal apparatus supports a prescribed function, or information indicating that the terminal apparatus has completed introduction and testing of a prescribed function. The information for indicating whether the prescribed function is supported includes information for indicating whether the introduction and testing of the prescribed function have been completed. In a case that the terminal apparatus supports the prescribed function, the terminal apparatus transmits information (parameters) for indicating whether the prescribed function is supported. In a case that the terminal apparatus does not support the prescribed function, the terminal apparatus may be configured not to transmit information (parameters) for indicating whether the prescribed function is supported. In other words, whether the prescribed function is supported is notified by whether information (parameters) for indicating whether the prescribed function is supported is transmitted. The information (parameters) for indicating whether the prescribed function is supported may be notified by using one bit of 1 or 0.

The information related to the function of the terminal apparatus includes information indicating that the grant free access is supported (information indicating whether to support each of UL-TWG-type1 and UL-TWG-type2). In a case that multiple functions corresponding to the grant free access are provided, the higher layer processing unit 206 can receive information indicating whether the grant free access is supported on a function-by-function basis. The information indicating that the grant free access is supported includes information indicating the multi-access physical resource and multi-access signature resource supported by the terminal apparatus. The information indicating that the grant free access is supported may include a configuration of a lookup table for the configuration of the multi-access physical resource and the multi-access signature resource. The information indicating that the grant free access is supported may include some or all of an antenna port, a capability corresponding to multiple tables indicating a scrambling identity and the number of layers, a capability corresponding to a prescribed number of antenna ports, and a capability corresponding to a prescribed transmission mode. The transmission mode is determined by the number of antenna ports, transmission diversity, the number of layers, and whether support of the grant free access and the like are provided.

The information related to the function of the terminal apparatus may include information indicating that a function related to URLLC is supported. For example, DCI formats for uplink dynamic scheduling or SPS/grant free access, and downlink dynamic scheduling or SPS include a compact DCI format with a small total number of information bits in the fields of the DCI format, and the information related to the function of the terminal apparatus may include information indicating that reception processing (blind decoding) for the compact DCI format is supported. The DCI is allocated and transmitted in a search space of the PDCCH, but the number of resources that can be used is determined for each aggregation level. Thus, the total number of information bits in the DCI format field being larger corresponds to a higher coding rate, and the total number of bits in the DCI format field being smaller corresponds to a lower coding rate. Thus, in a case that high reliability such as in URLLC is required, a lower coding rate is preferably used by using a compact DCI format. Note that DCI in a prescribed DCI format is allocated to resource elements (search space) determined in advance in LTE or NR. Thus, with a certain number of resource elements (aggregation level), a DCI format with a large payload size corresponds to a transmission with a higher coding rate than that of a DCI format with a small payload size, and this hinders satisfaction of high reliability.

The information related to the function of the terminal apparatus may include information indicating that various functions related to URLLC are supported. For example, information may be included that indicates that a reliable detection function (detection by blind decoding) for the PDCCH is supported by receiving DCI for which pieces of DCI format information regarding dynamic scheduling in uplink and downlink are transmitted in an overlapping manner. In a case that the overlapping pieces of DCI format information are transmitted on the PDCCH, the base station apparatus may repeatedly transmit information in the same DCI format in accordance with a prescribed rule such that the following are associated with one another: candidates for blind decoding in the search space for the pieces of DCI transmitted in an overlapping manner, the aggregation level, the search space, a CORESET, the BWP, the serving cell, and slots. This repeated transmission may be performed within a single piece of DCI or using multiple pieces of DCI.

The information related to the function of the terminal apparatus includes information indicating that a function related to carrier aggregation is supported. Additionally, the information related to the function of the terminal apparatus may include information indicating the support of a function related to simultaneous transmission of multiple component carriers (serving cells) (including overlapping in the time domain, overlapping in at least some OFDM symbols, or the like).

The higher layer processing unit 206 manages various types of configuration information about the terminal apparatus. Some of the various types of configuration information are input to the controller 208. The various types of configuration information are transmitted from the base station apparatus 10 via the transmitter 210 using the downlink physical channel. The various types of configuration information include configuration information related to grant free access input from the transmitter 210. The configuration information related to grant free access includes configuration information about the multi-access resources (multi-access physical resources and multi-access signature resources). For example, the configuration information related to grant free access may include configurations related to multi-access signature resources (configurations related to processing performed based on a mark for identifying the uplink physical channel transmitted by the terminal apparatus 20), such as an uplink resource block configuration (the start position of the OFDM symbols used and the number of OFDM symbols/the number of resource blocks), a configuration of the demodulation reference signal/identification signal (reference signal sequence, cyclic shift, OFDM symbols to be mapped, and the like), a spreading code configuration (Walsh code, Orthogonal Cover Code (OCC), sparse code, spreading rates of these spreading codes, and the like), an interleaving configuration, a transmit power configuration, a transmit and/or receive antenna configuration, and a transmit and/or receive beamforming configuration. These multi-access signature resources may be directly or indirectly associated (linked) with one another. The association of the multi-access signature resources is indicated by a multi-access signature process index. Additionally, the configuration information related to grant free access may include the configuration of the look-up table for the configuration of the multi-access physical resource and multi-access signature resource. The configuration information related to grant free access may include setup of the grant free access, information indicating release, ACK/NACK reception timing information for uplink data signals, retransmission timing information for uplink data signals, and the like.

Based on the configuration information that is related to grant free access and notified as control information, the higher layer processing unit 206 manages multi-access resources (multi-access physical resources, multi-access signature resources) for uplink data (transport blocks) transmitted through a grant free. Based on the configuration information related to grant free access, the higher layer processing unit 206 outputs, to the controller 208, information used to control the receiver 204.

The higher layer processing unit 206 outputs, to the transmitter 210, downlink data generated (e.g., DL-SCH). The downlink data may include a field storing the UE ID (RNTI). The higher layer processing unit 206 adds the CRC to the downlink data. Parity bits of the CRC are generated using the downlink data. The parity bits of the CRC are scrambled with the UE ID (RNTI) allocated to the addressed terminal apparatus (the scrambling is also referred to as an exclusive-OR operation, masking, or ciphering). However, as described above, multiple types of RNTIs are present, and the RNTI used varies depending on the data transmitted and the like.

The higher layer processing unit 206 generates, or acquires from a higher node, system information (MIB, SIB) to be broadcasted. The higher layer processing unit 206 outputs, to the transmitter 210, the system information to be broadcasted. The system information to be broadcasted can include information indicating that the base station apparatus 10 supports the grant free access. The higher layer processing unit 206 can include, in the system information, a portion or all of the configuration information related to grant free access (such as the configuration information related to the multi-access resources such as the multi-access physical resource, the multi-access signature resource). The uplink system control information is mapped to the physical broadcast channel/physical downlink shared channel in the transmitter 210.

The higher layer processing unit 206 generates or acquires from a higher node, downlink data (transport blocks) to be mapped to the physical downlink shared channel, system information (SIB), an RRC message, a MAC CE, and the like, and outputs the downlink data and the like to the transmitter 210. The higher layer processing unit 206 can include, in the higher layer signaling, some or all of the configuration information related to grant free access and parameters indicating setup and/or release of the grant free access. The higher layer processing unit 206 may generate a dedicated SIB for notifying the configuration information related to grant free access.

The higher layer processing unit 206 maps the multi-access resources to the terminal apparatuses 20 supporting grant free access. The base station apparatus 10 may hold a lookup table of configuration parameters for the multi-access signature resource. The higher layer processing unit 206 allocates each configuration parameter to the terminal apparatuses 20. The higher layer processing unit 206 uses the multi-access signature resource to generate configuration information related to grant free access for each terminal apparatus. The higher layer processing unit 206 generates a downlink shared channel including a portion or all of the configuration information related to grant free access for each terminal apparatus. The higher layer processing unit 206 outputs, to the controller 208/transmitter 210, the configuration information related to grant free access.

The higher layer processing unit 206 configures a UE ID for each terminal apparatus and notifies the terminal apparatus of the UE ID. As the UE ID, a Cell Radio Network Temporary Identifier (RNTI) can be used. The UE ID is used for the scrambling of the CRC added to the downlink control channel and the downlink shared channel. The UE ID is used for scrambling of the CRC added to the uplink shared channel. The UE ID is used to generate an uplink reference signal sequence. The higher layer processing unit 206 may configure an SPS/grant free access-specific UE ID. The higher layer processing unit 206 may configure the UE ID separately depending on whether or not the terminal apparatus supports grant free access. For example, in a case that the downlink physical channel is transmitted in the scheduled access and the uplink physical channel is transmitted in the grant free access, the UE ID for the downlink physical channel may be configured separately from the UE ID for the downlink physical channel. The higher layer processing unit 206 outputs the configuration information related to the UE ID to the transmitter 210/controller 208/receiver 204.

The higher layer processing unit 206 determines the coding rate, the modulation scheme (or MCS), and the transmit power for the physical channels (physical downlink shared channel, physical uplink shared channel, and the like). The higher layer processing unit 206 outputs the coding rate/modulation scheme/transmit power to the transmitter 210/controller 208/receiver 204. The higher layer processing unit 206 can include the coding rate/modulation scheme/transmit power in higher layer signaling.

In a case that downlink data to be transmitted is generated, the transmitter 210 transmits the physical downlink shared channel. Additionally, in a case of transmitting a resource for data transmission by using the DL Grant, the transmitter 210 may transmit the physical downlink shared channel through the scheduled access, and transmit the physical downlink shared channel for the SPS in a case that the SPS is activated. The transmitter 210 generates the physical downlink shared channel and the demodulation reference signal/control signal associated with the physical downlink shared channel in accordance with the configuration related to the scheduled access/SPS input from the controller 208.

The coding unit 2100 codes the downlink data input from the higher layer processing unit 206 by using the predetermined coding scheme/coding scheme configured by the controller 208 (the coding includes repetitions). The coding scheme may involve application of convolutional coding, turbo coding, Low Density Parity Check (LDPC) coding, Polar coding, and the like. The LDPC code may be used for data transmission, whereas the Polar code may be used for transmission of the control information. Different error correction coding may be used depending on the downlink channel to be used. Different error correction coding may be used depending on the size of the data or control information to be transmitted. For example, the convolution code may be used in a case that the data size is smaller than a prescribed value, and otherwise the correction coding described above may be used. For the coding described above, in addition to a coding rate of 1/3, a mother code such as a low coding rate of 1/6 or 1/12 may be used. In a case that a coding rate higher than the mother code is used, the coding rate used for data transmission may be achieved by rate matching (puncturing). The modulation unit 2102 modulates coded bits input from the coding unit 2100, in compliance with a modulation scheme notified in the downlink control information or a modulation scheme predetermined for each channel, such as BPSK, QPSK, 16QAM, 64QAM, or 256QAM (the modulation scheme may include π/2 shift BPSK or π/4 shift QPSK).

The multiple-access processing unit 2106 performs signal conversion such that the base station apparatus 10 can achieve signal detection even in a case that multiple data are multiplexed on a sequence output from the modulation unit 2102 in accordance with multi-access signature resource input from the controller 208. In a case that the multi-access signature resource is configured as spreading, multiplication by the spreading code sequence is performed according to the configuration of the spreading code sequence. Note that, in a case that interleaving is configured as a multi-access signature resource in the multiple-access processing unit 2106, the multiple-access processing unit 2106 can be replaced with the interleaving unit. The interleaving unit performs interleaving processing on the sequence output from the modulation unit 2102 in accordance with the configuration of the interleaving pattern input from the controller 208. In a case that code spreading and interleaving are configured as a multi-access signature resource, the multiple-access processing unit 2106 of the transmitter 210 performs spreading processing and interleaving. A similar operation is performed even in a case that any other multi-access signature resource is applied, and the sparse code or the like may be applied.

With an OFDM signal waveform, the multiple-access processing unit 2106 inputs, to the multiplexing unit 2108, a signal resulting from multiple-access processing. The downlink reference signal generation unit 2112 generates a demodulation reference signal in accordance with the configuration information about the demodulation reference signal input from the controller 208. The configuration information of the demodulation reference signal/identification signal generates a sequence determined according to a prescribed rule based on information such as the number of OFDM symbols notified by the base station apparatus in the downlink control information, the OFDM symbol positions in which the DMRS is allocated, the cyclic shift, time domain spreading, and the like.

The multiplexing unit 2108 performs multiplexing to map the downlink physical channel and the downlink reference signal to resource elements (mapping or allocation) for each transmit antenna port. In a case of using the SCMA, the multiplexing unit 2108 maps the downlink physical channel to resource elements in accordance with an SCMA resource pattern input from the controller 208.

The IFFT unit 2109 performs the Inverse Fast Fourier Transform (IFFT) on the multiplexed signal to execute OFDM modulation to generate OFDM symbols. The radio transmitting unit 2110 adds CPs to the OFDM modulated symbols to generate a baseband digital signal. Furthermore, the radio transmitting unit 2110 converts the baseband digital signal into an analog signal, removes the excess frequency components from the analog signal, converts the signal into a carrier frequency by up-conversion, performs power amplification, and transmits the resultant signal to the terminal apparatus 20 via the transmit antenna 212. The radio transmitting unit 2110 includes a transmit power control function (transmit power controller). The transmit power control follows configuration information about the transmit power input from the controller 208. Note that, in a case that FBMC, UF-OFDM, or F-OFDM is applied, filtering is performed on the OFDM symbols in units of subcarriers or sub-bands.

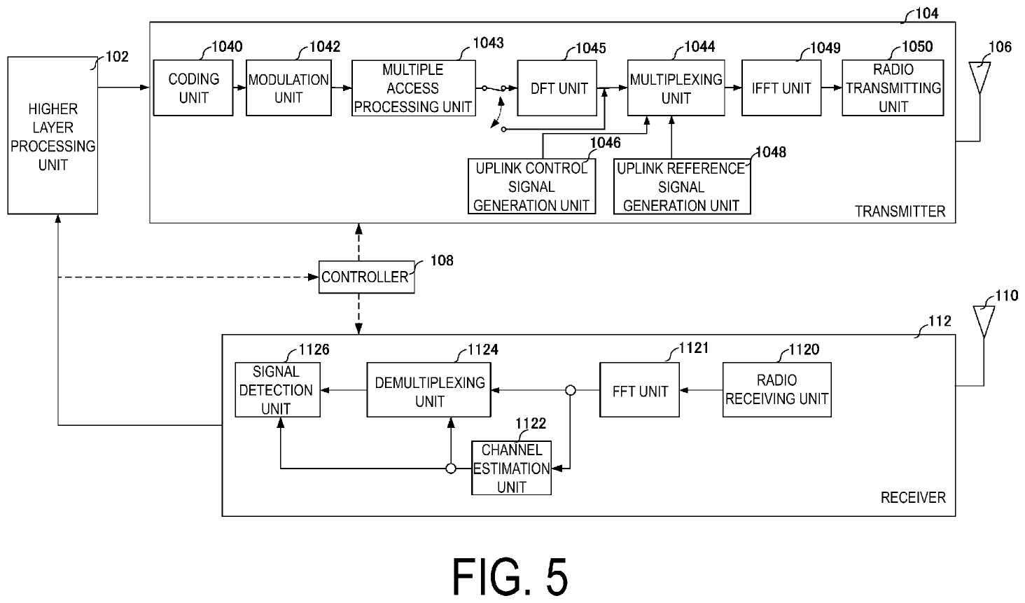

FIG. 5 is a schematic block diagram illustrating a configuration of the terminal apparatus 20 according to the present embodiment. The terminal apparatus 20 includes a higher layer processing unit (higher layer processing step) 102, a transmitter (transmitting step) 104, a transmit antenna 106, a controller (control step) 108, a receive antenna 110, and a receiver (receiving step) 112. The transmitter 104 includes a coding unit (coding step) 1040, a modulation unit (modulating step) 1042, a multiple-access processing unit (multiple-access processing step) 1043, a multiplexing unit (multiplexing step) 1044, a DFT unit (DFT step) 1045, an uplink control signal generation unit (uplink control signal generating step) 1046, an uplink reference signal generation unit (uplink reference signal generating step) 1048, an IFFT unit 1049 (IFFT step), and a radio transmitting unit (radio transmitting step) 1050. The receiver 112 includes a radio receiving unit (radio receiving step) 1120, an FFT unit (FFT step) 1121, a channel estimation unit (channel estimating step) 1122, a demultiplexing unit (demultiplexing step) 1124, and a signal detection unit (signal detecting step) 1126.

The higher layer processing unit 102 performs processing of layers higher than the physical layer, such as the Medium Access Control (MAC) layer, the Packet Data Convergence Protocol (PDCP) layer, the Radio Link Control (RLC) layer, and the Radio Resource Control (RRC) layer. The higher layer processing unit 102 generates information needed to control the transmitter 104 and the receiver 112, and outputs the resultant information to the controller 108. The higher layer processing unit 102 outputs uplink data (e.g., UL-SCH), uplink control information, and the like to the transmitter 104.

The higher layer processing unit 102 transmits information related to the terminal apparatus, such as the function of the terminal apparatus (UE capability) and the like, from the base station apparatus 10 (via the transmitter 104). The information related to the terminal apparatus includes information indicating that grant free access and/or reception/detection/blind decoding of the compact DCI are supported, information indicating the support of reception/detection/blind decoding in a case that the information of the repeated DCI format is transmitted on the PDCCH, and information indicating whether support is provided for each function. The information indicating that the grant free access is supported and the information indicating whether the grant free access is supported on a function-by-function basis may be distinguished from each other based on the transmission mode.

Based on the various types of configuration information input from the higher layer processing unit 102, the controller 108 controls the transmitter 104 and the receiver 112. The controller 108 generates uplink control information (UCI), based on the configuration information related to control information input from the higher layer processing unit 102, and outputs the uplink control information generated to the transmitter 104.

The transmitter 104 codes and modulates, for each terminal apparatus, the uplink control information, the uplink shared channel, and the like input from the higher layer processing unit 102, to generate a physical uplink control channel and a physical uplink shared channel. The coding unit 1040 codes the uplink control information and the uplink shared channel by using a predetermined coding scheme/a coding scheme notified by using control information. The coding scheme may involve application of convolutional coding, turbo coding, Low Density Parity Check (LDPC) coding, Polar coding, and the like. The modulation unit 1042 modulates coded bits input from the coding unit 1040 by using a predetermined modulation scheme/a modulation scheme notified by using the control information, such as the BPSK, QPSK, 16QAM, 64QAM, or 256QAM.

The multiple-access processing unit 1043 performs signal conversion such that the base station apparatus 10 can achieve signal detection even in a case that multiplexing of multiple data is performed on a sequence output from the modulation unit 1042 in accordance with multi-access signature resource input from the controller 108. In a case that the multi-access signature resource is configured as spreading, multiplication by the spreading code sequence is performed according to the configuration of the spreading code sequence. The configuration of the spreading code sequence may be associated with other configurations of the grant free access such as the demodulation reference signal/identification signal. Note that the multiple-access processing may be performed on a sequence resulting from DFT processing. Note that, in a case that interleaving is configured as a multi-access signature resource in the multiple-access processing unit 1043, the multiple-access processing unit 1043 can be replaced with the interleaving unit. The interleaving unit performs interleaving processing on the sequence output from the DFT unit in accordance with the configuration of the interleaving pattern input from the controller 108. In a case that code spreading and interleaving are configured as a multi-access signature resource, the transmitter 104 and the multiple-access processing unit 1043 perform spreading processing and interleaving. A similar operation is performed even in a case that any other multi-access signature resource is applied, and the sparse code or the like may be applied.

The multiple-access processing unit 1043 inputs the signal resulting from multiple access processing to the DFT unit 1045 or the multiplexing unit 1044 depending on whether a DFTS-OFDM signal waveform or an OFDM signal waveform is used. In a case that the DFTS-OFDM signal waveform is used, the DFT unit 1045 rearranges, in parallel, modulation symbols resulting from the multiple access processing and output from the multiple-access processing unit 1043 and then performs Discrete Fourier Transform (DFT) processing on the modulation symbols rearranged. Here, a zero symbol sequence may be added to the modulation symbols, and the DFT may then be performed to provide a signal waveform in which, instead of a CP, a zero interval is used for a time signal resulting from IFFT. A specific sequence such as Gold sequence or a Zadoff-Chu sequence may be added to the modulation symbols, and the DFT may then be performed to provide a signal waveform in which, instead of a CP, a specific pattern is used for the time signal resulting from the IFFT. In a case that the OFDM signal waveform is used, the DFT is not applied, and thus the signal resulting from multiple access processing is input to the multiplexing unit 1044. The controller 108 performs control by using a configuration of the zero symbol sequence (the number of bits in the symbol sequence and the like) and a configuration of the specific sequence (sequence seed, sequence length, and the like), the configurations being included in the configuration information related to grant free access.

The uplink control signal generation unit 1046 adds a CRC to uplink control information input from the controller 108, to generate a physical uplink control channel. The uplink reference signal generation unit 1048 generates an uplink reference signal.

The multiplexing unit 1044 maps the modulation symbols of each modulated uplink physical channel from the multiple-access processing unit 1043 or the DFT unit 1045, the physical uplink control channel, and the uplink reference signal to the resource elements. The multiplexing unit 1044 maps the physical uplink shared channel and the physical uplink control channel to resources allocated to each terminal apparatus.

The IFFT unit 1049 performs Inverse Fast Fourier Transform (IFFT) on the modulation symbols of each multiplexed uplink physical channel to generate OFDM symbols. The radio transmitting unit 1050 adds cyclic prefixes (CPs) to the OFDM symbols to generate a baseband digital signal. Furthermore, the radio transmitting unit 1050 converts the digital signal into an analog signal, removes excess frequency components from the analog signal by filtering, performs up-conversion to the carrier frequency, performs power amplification, and outputs the resultant signal to the transmit antenna 106 for transmission.

The receiver 112 uses the demodulation reference signal to detect a downlink physical channel transmitted from the base station apparatus 10. The receiver 112 detects the downlink physical channel, based on the configuration information notified by the base station apparatus by using the control information (such as DCI, RRC, SIB, or the like). Here, the receiver 112 performs blind decoding on the search space included in the PDCCH and thus on candidates that are predetermined or notified by using higher layer control information (RRC signaling). As a result of blind decoding, the receiver 112 detects the DCI by using the CRC scrambled with the C-RNTI, the CS-RNTI, the INT-RNTI (both downlink and uplink RNTIs may be present), and other RNTIs. The blind decoding may be performed by the signal detection unit 1126 in the receiver 112, or may be performed by a control signal detection unit separately provided and not illustrated in the drawings.

The radio receiving unit 1120 converts, by down-conversion, an uplink signal received through the receive antenna 110 into a baseband signal, removes unnecessary frequency components from the baseband signal, controls the amplification level in such a manner as to suitably maintain a signal level, performs orthogonal demodulation based on an in-phase component and an orthogonal component of the received signal, and converts the resulting orthogonally-demodulated analog signal into a digital signal. The radio receiving unit 1120 removes a part corresponding to the CP from the converted digital signal. The FFT unit 1121 performs Fast Fourier Transform (FFT) on the signal from which the CPs have been removed, and extracts a signal in the frequency domain.

The channel estimation unit 1122 uses the demodulation reference signal to perform channel estimation for signal detection for the downlink physical channel. The channel estimation unit 1122 receives, as inputs from the controller 108, the resources to which the demodulation reference signal is mapped and the demodulation reference signal sequence allocated to each terminal apparatus. The channel estimation unit 1122 uses the demodulation reference signal sequence to measure the channel state between the base station apparatus 10 and the terminal apparatus 20. The demultiplexing unit 1124 extracts the frequency domain signal input from the radio receiving unit 1120 (the signal includes signals from multiple terminal apparatuses 20). The signal detection unit 1126 uses the channel estimation result and the frequency domain signal input from the demultiplexing unit 1124 to detect a signal of downlink data (uplink physical channel).

The higher layer processing unit 102 acquires downlink data (bit sequence resulting from hard decision) from the signal detection unit 1126. The higher layer processing unit 102 performs descrambling (exclusive-OR operation) on the CRC included in the decoded downlink data for each terminal apparatus, by using the UE ID (RNTI) allocated to the terminal. In a case that no error is found in the downlink data as a result of descrambling error detection, the higher layer processing unit 102 determines that the downlink data has been correctly received.

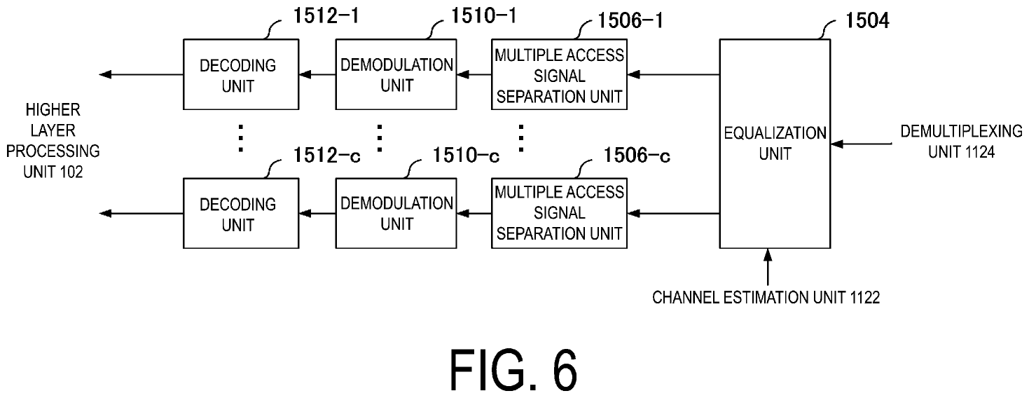

FIG. 6 is a diagram illustrating an example of the signal detection unit according to the present embodiment. The signal detection unit 1126 includes an equalization unit 1504, multiple-access signal separation units 1506-1 to 1506-c, demodulation units 1510-1 to 1510-c, and decoding units 1512-1 to 1512-c.

The equalization unit 1504 generates an equalization weight based on the MMSE standard, from the frequency response input from the channel estimation unit 1122. Here, MRC and ZF may be used for the equalization processing. The equalization unit 1504 multiplies the equalization weight by the frequency domain signal input from the demultiplexing unit 1124, and extracts the frequency domain signal. The equalization unit 1504 outputs the equalized frequency domain signal to the multiple-access signal separation units 1506-1 to 1506-c. c is 1 or greater and is the number of signals, for example, the PUSCH and PUCCH, which are received in the same subframe, the same slot, and the same OFDM symbol. Reception of other downlink channels may be performed at the same timing.

The multiple-access signal separation units 1506-1 to 1506-c separate the signal mapped to the time domain signal by multiplexing using the multi-access signature resource (multiple-access signal separation processing). For example, in a case that code spreading is used as a multi-access signature resource, each of the multiple-access signal separation units 1506-1 to 1506-c performs despread processing using a spreading code sequence used. Note that, in a case that interleaving is applied as a multi-access signature resource, de-interleaving is performed on the time domain signal (deinterleaving unit).

The demodulation units 1510-1 to 1510-c receive, as an input from the controller 108, pre-notified or predetermined information about the modulation scheme for each terminal apparatus. Based on the information about the modulation scheme, the demodulation units 1510-1 to 1510-c perform demodulation processing on the separated multiple-access signal, and outputs the Log Likelihood Ratio (LLR) of the bit sequence.

The decoding units 1512-1 to 1512-c receive, as an input from the controller 108, pre-notified or predetermined information about the coding rate. The decoding units 1512-1 to 1512-c perform decoding processing on the LLR sequences output from the demodulation units 1510-1 to 1510-c. In order to perform cancellation processing such as a Successive Interference Canceller (SIC) or turbo equalization, the decoding units 1512-1 to 1512-c may generate a replica from external LLRs or post LLRs output from the decoding units and perform the cancellation processing. A difference between the external LLR and the post LLR is whether to subtract, from the decoded LLR, the pre LLR input to each of the decoding units 1512-1 to 1512-c or not.

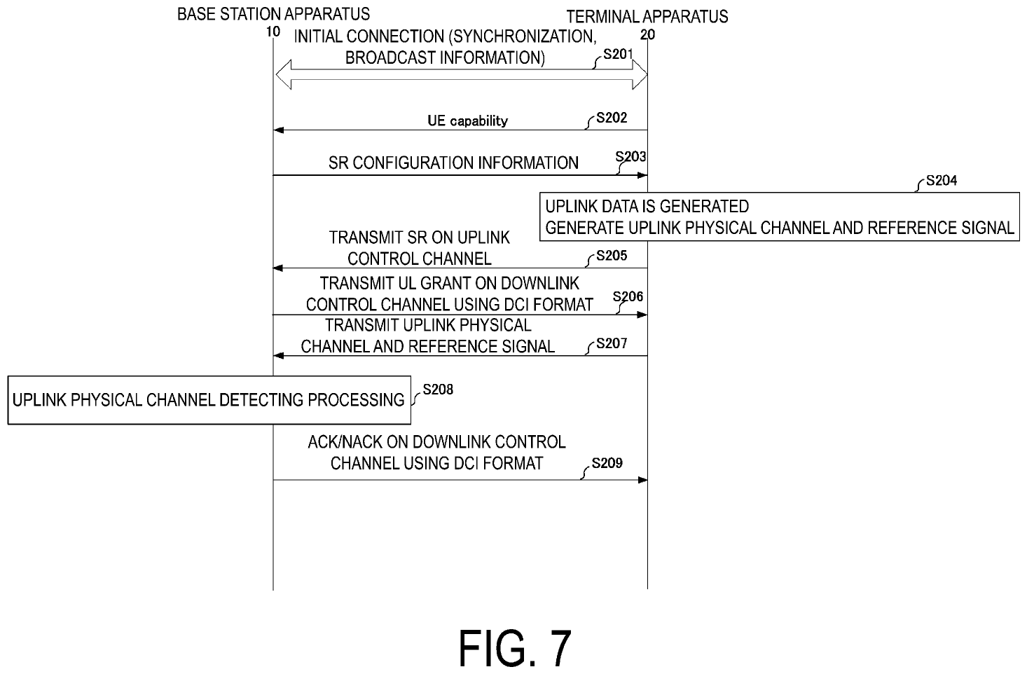

FIG. 7 illustrates an example of a sequence chart of uplink data transmission for dynamic scheduling. The base station apparatus 10 periodically transmits a synchronization signal and a broadcast channel in accordance with a prescribed radio frame format in the downlink. The terminal apparatus 20 performs an initial connection by using the synchronization signal, the broadcast channel, and the like (S201). The terminal apparatus 20 performs frame synchronization and symbol synchronization in the downlink by using the synchronization signal. In a case that the broadcast channel includes the configuration information related to grant free access, the terminal apparatus 20 acquires the configuration related to grant free access in the connected cell. The base station apparatus 10 can notify each terminal apparatus 20 of the UE ID in the initial connection.

The terminal apparatus 20 transmits the UE Capability (S202). The base station apparatus 10 uses the UE Capability to determine whether the terminal apparatus 20 supports grant free access or not, whether the terminal apparatus 20 supports URLLC data transmission or not, whether the terminal apparatus 20 supports eMBB data transmission or not, whether the terminal apparatus 20 supports transmission of multiple types of SRs or not, whether the terminal apparatus 20 supports data transmission using different MCS tables or not, whether the terminal apparatus supports detection of Compact DCI including fewer bits than that of each of DCI formats 0_0 and 0_1 or not, whether the terminal apparatus 20 supports detection of a repeatedly transmitted DCI format or not, and whether the terminal apparatus 20 supports detection of group common DCI or not. Note that in S201 to S203, the terminal apparatus 20 can transmit the physical random access channel to acquire resources for uplink synchronization and an RRC connection request.

The base station apparatus 10 uses the RRC message, the SIB, and the like to transmit, to each of the terminal apparatuses 20, configuration information for a scheduling request (SR) requesting radio resources for uplink data transmission (S203). Here, the configuration information for two types of scheduling requests (SRs) requesting radio resources for uplink data transmission may be transmitted to each of the terminal apparatuses 20. Here, for the SR configuration, multiple configurations can be provided for a PUCCH format used (0 or 1), resources for the PUCCH, the duration of a transmission prohibition timer after SR transmission, the maximum number of SR transmissions, and the period and the offset at which the SR can be transmitted, and the SR configuration accommodates multiple serving cells, BWPs, and PUCCH formats used. Two types of configurations for an SR for uplink eMBB and an SR for uplink URLLC may be notified. Note that the base station apparatus may notify three or more types of SR configuration information including an SR for mMTC and the like.

In an example of a method of notifying SRs for eMBB and URLLC, one or more (one or more sets) of multiple SR transmission configurations (a set of configurations includes PUCCH resources, the PUCCH format, the period and offset at which the SR can be transmitted, the duration of the transmission prohibition timer after SR transmission, and the maximum number of SR transmissions) may be specified as SR transmission configurations for URLLC through higher layer signaling such as RRC signaling. Additionally, an ID (SchedulingRequestId) indicating a set of the duration of the transmission prohibition timer after SR transmission and the maximum number of SR transmissions may be used to specify one or more IDs as SR transmission configurations for URLLC through higher layer signaling such as RRC signaling. In addition, an ID (SchedulingRequestResourceId) indicating a set of PUCCH resources, the PUCCH format, and the period and offset at which the SR can be transmitted may be used to specify one or more IDs as SR transmission configurations for URLLC through higher layer signaling such as RRC signaling. Multiple types of IDs used as SR transmission configurations may be used at a time.

As described above, in a case that a set of SR transmission configurations or one of IDs is used to notify SR transmission configurations for URLLC, and multiple sets or multiple IDs are specified as SR transmission configurations for URLLC, up to a prescribed number of transmission configurations from the multiple transmission configurations for URLLC may be activated, and, through switching of the BWP or activation/deactivation of the serving cell, inactive SR transmission configurations for URLLC may be replaced with active SR configurations for URLLC, or the active SR transmission configurations for URLLC may be inactivated and newly specified SR transmission configurations for URLLC may be made active for configuration. As an example, in a case that the base station apparatus specifies three sets or IDs as SR transmission configurations for URLLC, and only one set or ID is activated from the specified SR transmission configurations for URLLC, the SR transmission based on the active SR transmission configurations for URLLC may be used as a scheduling request for URLLC, whereas the SR transmission based on the two other specified sets or IDs of SR transmission configurations for URLLC may be used as a scheduling request for eMBB. In spite of SR transmission configurations for URLLC, in a case that a part of the associated BWP for URLLC is inactive, inactive configurations from the SR transmission configurations for URLLC may be used as a scheduling request for eMBB. In a case that multiple sets or IDs are specified as SR transmission configurations for URLLC, prioritization information may also be added, and a set or an ID associated with an active BWP with a high priority may be used as SR transmission configurations for URLLC. In addition, the configuration of the priority may be configured based on, instead of the SR transmission configuration information, the BWP or the serving cell, the type such as PCell/PSCell/SCell (for example, the PCell is prioritized), the type of a cell group (CG) (e.g., the MCG is prioritized), whether or not SUL (e.g., the SUL is prioritized), the subcarrier spacing configured (e.g., a larger subcarrier spacing is preferred), or the configured unit of the PUCCH format. Note that, for one terminal apparatus in one serving cell, four BWPs can be configured, and only one BWP can be activated. In a case that one terminal apparatus simultaneously configures multiple connections for URLLC, different SR transmission configurations may be provided for the respective connections. For example, different SR configurations may be provided for the respective multiple scheduling request IDs, and the different scheduling request IDs may be used as SRs for the respective connections for URLLC.

With multiple sets of SR transmission configurations or multiple IDs being used to specify SR transmission configurations for URLLC as described above, in a case that a band that can be used is changed due to switching of the active BWP or deactivation of the serving cell based on the timer or the DCI, SR transmission configurations for URLLC can also be switched.

In S202, the higher layer information such as the RRC message, SIBs, and the like may include configuration information related to the Compact DCI or grant free access. The configuration information related to grant free access may include allocation of multi-access signature resources. Additionally, the higher layer information such as the RRC message and SIBs may include configuration information related to the BWP.

In a case that uplink data for URLLC is generated, the terminal apparatus 20 generates an SR signal in a specified PUCCH format, based on the SR transmission configurations for URLLC (S204). Here, generation of uplink data for URLLC may refer to provision of a transport block for URLLC data by the higher layer. The terminal apparatus 20 transmits the SR signal on the uplink control channel based on the SR transmission configurations for URLLC (S205). In a case of detecting an SR based on the SR transmission configurations for URLLC, the base station apparatus 10 transmits the UL Grant for URLLC in the DCI format to the terminal apparatus 20 on the downlink control channel (S206). Here, the UL Grant for URLLC may use the Compact DCI, transmit the same DCI repeatedly, or differ from data transmission for eMBB in one of the scheduling information, the method for specifying the MCS, and the method for specifying the HARQ process number. The uplink physical channel and the demodulation reference signal are transmitted (initial transmission) (S207). The terminal apparatus 20 uses different physical channels for data transmission based on the UL Grant for dynamic scheduling and for transmission based on grant free access/SPS, and may use, for transmission, resources that can be used at data transmission timings (slots or OFDM symbols). The base station apparatus 10 detects the uplink physical channel transmitted by the terminal apparatus 20 (S208). Based on the result of the error detection, the base station apparatus 10 transmits the ACK/NACK to the terminal apparatus 20 on the downlink control channel by using the DCI format (S209). In S208, in a case that no errors are detected, the base station apparatus 10 determines to have correctly completed the reception of the received uplink data, and transmits the ACK. On the other hand, in a case that an error is detected in S208, the base station apparatus 10 determines to have incorrectly received the uplink data, and transmits the NACK.

Here, the notification of ACK/NACK for the uplink data transmission based on the UL Grant using the DCI uses the HARQ process ID and the NDI in the DCI format used for the UL Grant. Specifically, in a case that a DCI format including an HARQ process ID corresponding to the data transmission is detected and that the NDI is changed from the NDI value in the last detection of a DCI format with the same HARQ process ID (the value is in 1 bit, and has thus been toggled), the ACK is determined (in FIG. 7, in a case that the DCI detected in S206 and the DCI detected in S209 indicate the same HARQ process ID and that the NDI has been toggled, the ACK is determined), the detected DCI format is used as an uplink grant for new data transmission. In a case that the NDI values are the same (the detected value has not been toggled), the NACK is determined (in FIG. 7, in a case that the DCI detected in S206 and the DCI detected in S209 indicate the same HARQ process ID and that the NDI has not been toggled, the NACK is determined). In a case that the DCI format for the NACK is detected, the detected DCI format is used as an uplink grant for data transmission for retransmission.

Note that the DCI format for notifying the uplink grant in S206 may include frequency resource (resource block, resource block group, subcarrier) information to be used for uplink data transmission, and a relative time from a slot n in which the DCI format has been detected in the PDCCH to the uplink data transmission timing (e.g., assuming that the relative time is k, a slot n+k corresponds to the uplink data transmission timing), the number of OFDM symbols to be used in the slot corresponding to the uplink data transmission timing and the start position, and the number of continuous OFDM symbols. Additionally, the uplink grant may notify the data transmission in multiple slots, and in a case that the relative time indicating the uplink data transmission timing is k and that the data transmission is allowed from the slot n+k to a slot n+k+n′, the uplink grant includes the information of n′.

In a case of detecting the uplink grant through the blind decoding of the PDCCH, the terminal apparatus transmits the uplink data at the uplink data transmission timing specified by the uplink grant. Here, the uplink grant includes the HARQ process number (e.g., 4 bits), and the terminal apparatus performs the data transmission of the uplink grant corresponding to the HARQ process number specified by the uplink grant.

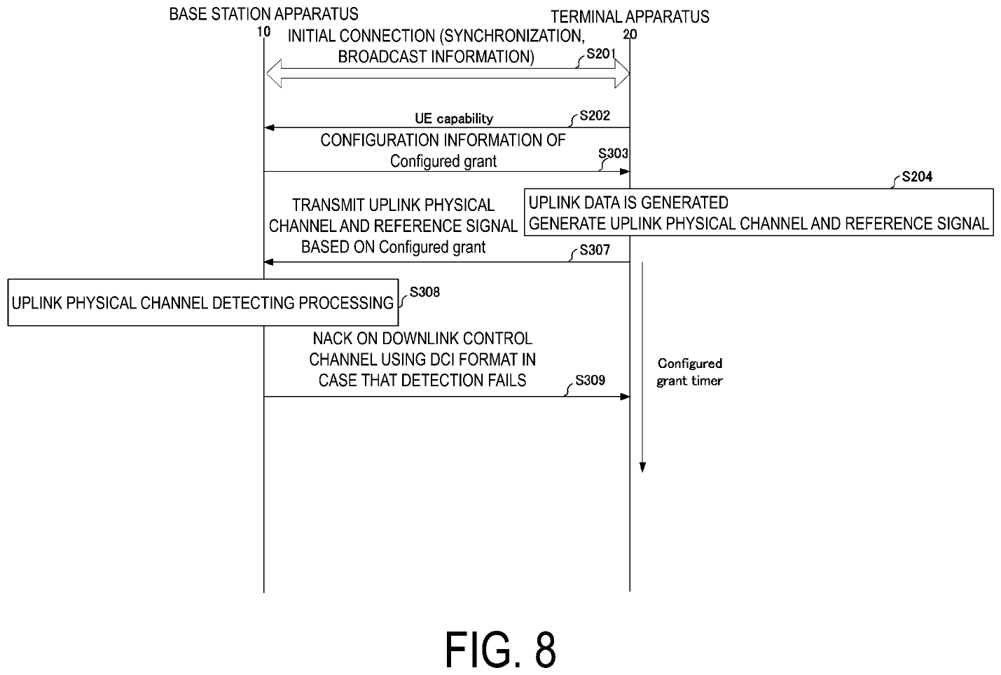

FIG. 8 illustrates an example of a sequence chart of uplink data transmission according to configured grant. The difference between FIG. 8 and FIG. 7 includes S303 and S307 to S309, and the processing of the difference from FIG. 7 will be described. In S202, the terminal apparatus uses the UE Capability to notify that the URLLC and eMBB data transmissions are supported. Here, the difference between the data transmission of the eMBB and the URLLC may correspond to a difference between the case where the uplink grant is received in DCI format 0_0/0_1 and the case where the uplink grant is received with the compact DCI including fewer control information bits than those of DCI format 0_0/0_1, or a difference between the case where the lowest Spectral efficiency of the MCS table used for data transmission is high and the case where the lowest spectral efficiency of the MCS table used for data transmission is low, or a difference in the MCS table that can be used for data transmission (for example, a difference in target block error rate), a difference between the dynamic scheduling and the SPS/Configured grant/grant free access, a difference between the case where the number of HARQ processes is 16 and the case where the number of HARQ processes is 4, a difference between the case where the number of repetitions of data transmission is equal to or less than a prescribed value (for example, 1 or less) and the case where the number of repetitions of data transmission is more than the prescribed value, or a difference between the case where the Logical CHannel (LCH) has a low priority and the case where the LCH has a high priority, or may depend on a QoS Class Indicator (QCI).

The base station apparatus 10 transmits the configuration information for Configured grant to each of the terminal apparatuses 20 by using the RRC message, SIBs, or the like (S303). Here, the configuration of Configured grant may be ConfiguredGrantConfig described above, or information including rrcConfiguredGrant in ConfiguredGrantConfig may be used. Additionally, the configuration of Configured grant may be indicated by information other than rrcConfiguredGrant. Here, in a case that rrcConfiguredGrant is included in ConfiguredGrantConfig, the data can be transmitted without notification of the DCI format. In a case that rrcConfiguredGrant is not included in ConfiguredGrantConfig, Configured grant data may be transmitted in conjunction with the ConfiguredGrantConfig information and the DCI format information.

The terminal apparatus transmits the uplink physical channel and the demodulation reference signal, based on the configuration information of Configured grant or the configuration information of Configured grant and the UL Grant for URLLC indicated by the DCI (initial transmission) (S307). The terminal apparatus starts a Configured Grant Timer for detection of the NACK during data transmission using the configuration information of Configured grant. The expiration time of the Configured Grant Timer may be specified by the base station apparatus 10, or may be predetermined between the base station apparatus 10 and the terminal apparatus. The base station apparatus 10 detects the uplink physical channel transmitted by the terminal apparatus 20, based on configured grant (S308). In a case of failing to detect the uplink physical channel transmitted by the terminal apparatus 20 and based on configured grant, the base station apparatus 10 transmits the NACK in the DCI format before the expiration time of the Configured Grant Timer (S309). Retransmission processing for the uplink transmission using Configured grant uses uplink transmission through dynamic scheduling, and thus the subsequent processing is the same as that illustrated in FIG. 7, and descriptions of the processing are omitted.

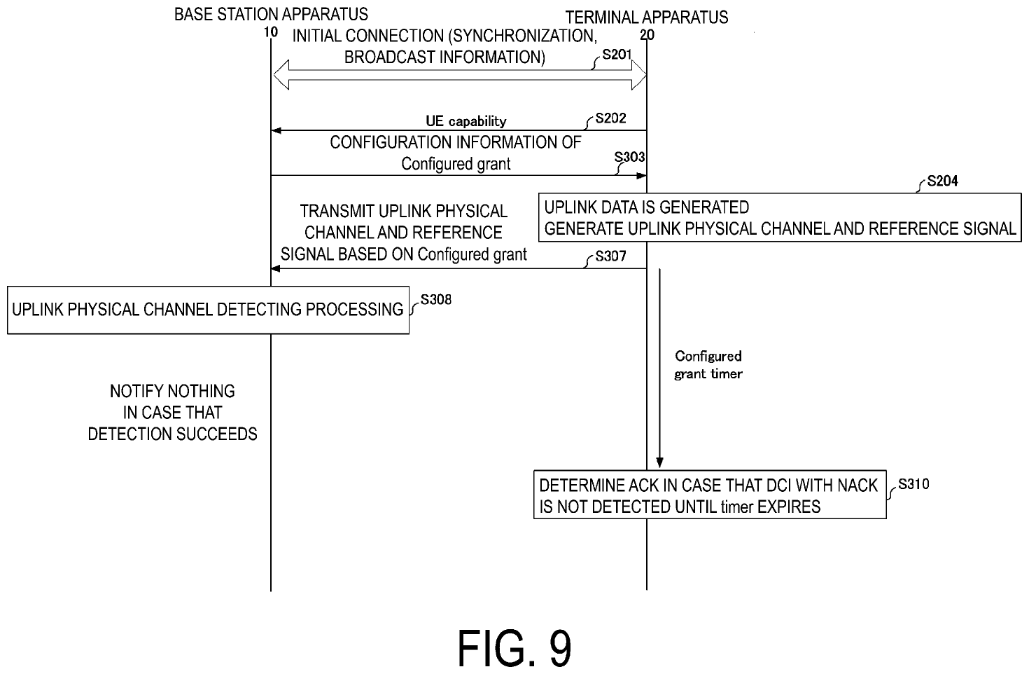

FIG. 9 illustrates an example of a sequence chart of uplink data transmission according to configured grant. FIG. 8 is a case where the data transmission based on the configured grant is NACK, but the data transmission based on the configured grant in FIG. 9 is an ACK. The base station apparatus 10 detects the uplink physical channel transmitted by the terminal apparatus 20 and based on configured grant (S308). In a case of succeeding in detecting the uplink physical channel transmitted by the terminal apparatus 20 and based on configured grant, the base station apparatus 10 notifies nothing. In other words, the terminal apparatus determines the ACK because the DCI format is not detected and the NACK is not detected before expiration of the Configured Grant Timer (S310).

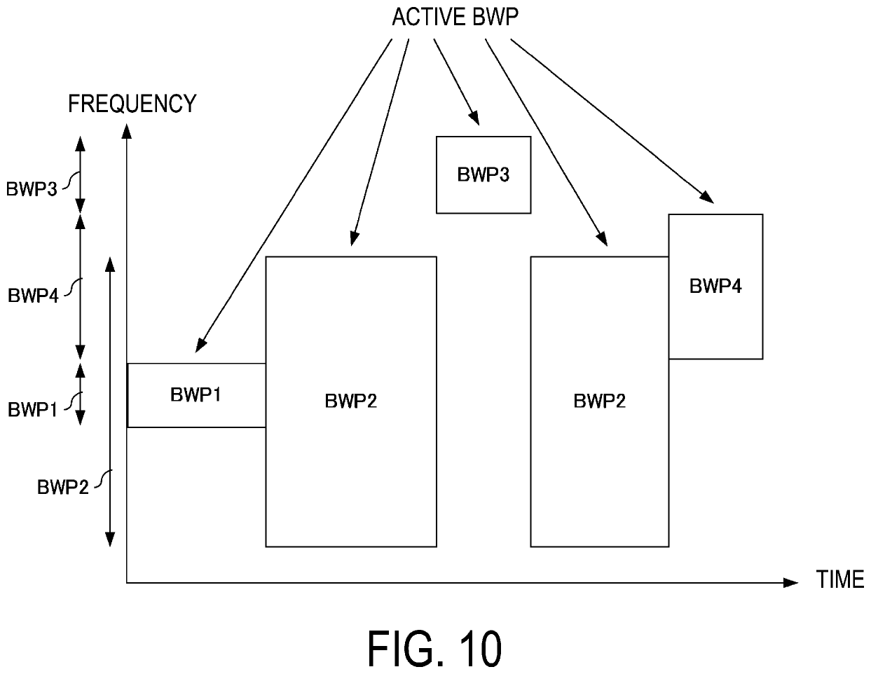

FIG. 10 is an example illustrating an operation of switching the BWP in one serving cell according to the first embodiment. FIG. 10 illustrates an example in which four BWPs are configured in one serving cell and include BWP1 corresponding to an initial BWP used first in a case that the serving cell is configured, BWP2 used for broadband transmission for eMBB and the like, BWP3 mainly used for URLLC and having subcarrier spacings of more than 15 kHz (for example, 30 kHz, 60 kHz, or the like), and BWP4 corresponding to a bandwidth intermediate between the BWP1 and the BWP2. An identifier (BWP-ID) may be configured for each BPW. The value of a prescribed identifier, e.g., ID=0, may be treated as the initial BWP. First, in a case that the serving cell is configured, the BWP1 configured as the initial BWP is activated. In a case that BWP switching in accordance with the DCI format activates the BWP2, the BWP1 is deactivated. This is because only one BWP can be activated in one serving cell. Furthermore, for data transmission or reception for URLLC, switching to the BWP3 is performed in accordance with the DCI format. Furthermore, BWP switching enables the active BWP to change to the BWP2 and then to the BWP4. In addition, BWP switching is not limited to the notification based on the DCI format, but is also performed in accordance with a BWP inactivity timer. In a case that BWP switching occurs, the terminal apparatus starts the BWP inactivity timer. The BWP inactivity timer is restarted in a case that a DCI format is detected in the active BWP. In a case that the BWP inactivity timer expires, the active BWP changes to the initial BWP. The BWP to which the BWP transitions in a case that the BWP inactivity timer expires may be a default BWP separately configured instead of the initial BWP. For example, the BWP2 in FIG. 10 is the default BWP (an example of the BWP different from the BWP1 corresponding to the initial BWP), and in a case that the BWP3 is activated by the BWP switching in accordance with the DCI format, the BWP inactivity timer is started. In a case that the BWP inactivity timer expires, the BWP2 is activated without BWP switching in accordance with the DCI format.

The DCI format enabling BWP switching is 0_1/1_1, which is greater in the number of information bits than DCI format 0_0/1_0 for fallback. At a certain aggregation level, the DCI format with a large number of information bits has a higher coding rate than the DCI format with a small number of information bits, and this leads to difficulty in maintaining high reliability. Thus, for URLLC, using DCI format 0_1/1_1 is not preferable for switching from the BWP2 to the BWP3 as in the example of FIG. 10. On the other hand, DCI format 0_0/1_0 for fallback includes no field specifying BWP switching, preventing notification of BWP switching. Additionally, even DCI format 0_0/1_0 may be insufficient for achieving the high reliability required for URLLC. Thus, in the present embodiment, BWP switching is performed in accordance with the Compact DCI format, a DCI format having even fewer information bits than those of DCI format 0_0/1_0. Hereinafter, the Compact DCI format includes DCI format 0_c used for notification of the uplink grant and DCI format 1_c used for notification of the downlink grant.

The base station apparatus performs configuration of scheduling on the terminal apparatus in accordance with the BWP and the Compact DCI format used for the data transmission for URLLC by using the RRC information. As an example, the Compact DCI format may be used to perform configuration of scheduling by configuration of the PDCCH (PDCCH-config) or configuration of the PDSCH (PDSCH-config) for configuration for each downlink BWP (BWP-Downlink) for configuration of the serving cell (ServingCellConfig) included in the RRC information. In the uplink, the Compact DCI format may be used to perform configuration of scheduling by configuration of the PUSCH (PUSCH-config) for configuration for each uplink BWP (BWP-Uplink in UplinkConfig) for configuration of the serving cell (ServingCellConfig) included in the RRC information.

First, a case will be described in which scheduling in accordance with the Compact DCI format is configured in only one of the multiple BWPs configured in one serving cell. An example will be described in which, in the downlink, scheduling in accordance with the Compact DCI format is configured in only one BWP through PDCCH-config or PDSCH-config, corresponding to a configuration for each BWP, and in which scheduling is configured in the BWP3 in FIG. 10. In other words, in this example, FIG. 10 illustrates a configuration status of the downlink BWPs. In FIG. 10, in a case that the BWP1 corresponding to the initial BWP used first in a case that the serving cell is configured is switched to the BWP2 in accordance with DCI format 1_1, downlink URLLC data is generated, and then the base station apparatus performs scheduling in accordance with DCI format 1_c. In this case, the active BWP corresponds to the BWP2, and thus DCI format 1_c is transmitted on the PDCCH in the BWP2. In a case that DCI format 1_c is detected by blind decoding, the terminal apparatus determines that the BWP2 is deactivated, whereas the BWP3 is activated. Furthermore, the terminal apparatus receives downlink data, based on the downlink grant in DCI format 1_c.

Now, an example in which, in the uplink, scheduling in accordance with the Compact DCI format is configured in only one BWP through PUSCH-config, corresponding to a configuration for each BWP, and in which scheduling is configured in the BWP3 in FIG. 10. In other words, in this example, FIG. 10 illustrates a configuration status of the uplink BWPs. In FIG. 10, a case is assumed in which the BWP1 corresponding to the initial BWP used first in a case that the serving cell is configured is switched to the BWP2 in accordance with DCI format 0_1. At this time, the terminal apparatus transmits a scheduling request after uplink URLLC data is generated. Here, the scheduling request may notify URLLC traffic by using a resource or parameter used for transmission of the scheduling request (such as a scheduling request ID). Thereafter, the base station apparatus performs scheduling in accordance with DCI format 0_c. In this case, the base station apparatus transmits DCI format 0_c on the PDCCH in the active downlink BWP. In a case of detecting DCI format 0_c by blind decoding, the terminal apparatus determines that the BWP2 is deactivated, whereas the BWP3 is activated. Furthermore, the terminal apparatus transmits uplink data based on the UL grant in DCI format 0_c.

As described above, in a case that downlink reception/uplink transmission in accordance with the Compact DCI format configured in the RRC information are performed in only one BWP, switching to the BWP for URLLC can be achieved even though the Compact DCI format includes no dedicated field for BWP switching. In other words, this configuration avoids increasing the number of information bits in the Compact DCI format in order to notify BWP switching, preventing an increased coding rate of the Compact DCI format. Thus, high reliability can be maintained. The Compact DCI is not provided with a field for BWP switching, and one BWP is associated with the Compact DCI format. With a constant amount of information in the Compact DCI, the number of times of blind decoding for the Compact DCI used for BWP switching need not be increased. Additionally, BWP switching of the present embodiment can also be applied to a transmission method for another DCI format, as well as the Compact DCI format. For example, in a case that the scheduling based on the repeated transmission of the DCI format is configured in one BWP in one serving cell and that the DCI format repeatedly transmitted by blind decoding is detected, switching to the BWP for URLLC may be performed as described above. As another example, in a case that the aggregation level is equal to or more than a prescribed value (8 or more, or 16 or more, or 32 or more), the configuration of switching to the BWP for URLLC may be performed using the RRC information. In addition, the RRC information may be used to provide a configuration in which switching to the BWP for URLLC is performed based on a combination of the aggregation level being at a prescribed value or larger and the prescribed search space (only a common search space, only a UE-specific search space, or the like). In addition, the RRC information may be used to provide a configuration in which switching to the BWP for URLLC is performed based on a combination of the aggregation level being at the prescribed value or larger and the prescribed DCI format (DCI format 0_0, DCI format 1_0, or the like). In addition, the RRC information may be used to provide a configuration in which switching to the BWP for URLLC is performed based on a combination of the aggregation level being at a prescribed value or larger, the prescribed search space (only the common search space, only the UE-specific search space, or the like), and the prescribed DCI format (DCI format 0_0 or DCI format 1_0).

In a case that switching to the BWP for URLLC is configured in only one of the multiple BWPs configured in one serving cell, operations after switching to the BWP for URLLC in accordance with the Compact DCI format or above-described another method will be described. At the time of switching to the BWP for URLLC, the terminal apparatus may start the BWP inactivity timer for URLLC. In a case of receiving the downlink/uplink grant for scheduling of the BWP for URLLC during operation of the BWP inactivity timer for URLLC, the terminal apparatus restarts the BWP inactivity timer for URLLC. In a case that the BWP inactivity timer for URLLC expires, the terminal apparatus may switch to the default BWP or the initial BWP. In a case that the BWP inactivity timer for URLLC expires, the terminal apparatus may switch to the BWP that has remained active until immediately before the BWP for URLLC is activated. In a case that the BWP to switch to in a case that the BWP inactivity timer for URLLC expires is configured using the RRC information, the terminal apparatus may switch to the BWP configured by the RRC information, in a case that the BWP inactivity timer for URLLC expires. The BWP inactivity timer for URLLC may also be used as an ordinary BWP inactivity timer or may be separately prepared.

As another example, at the time of switching to the BWP for URLLC, the terminal apparatus may activate the BWP for URLLC until the HARQ process for traffic for URLLC is completed. Specifically, in a case of switching to the BWP for URLLC in a case of detecting the downlink/uplink grant for traffic for URLLC, performing reception/transmission of data, and transmitting the ACK for downlink data/receiving the ACK for the uplink, the terminal apparatus may deactivate the BWP for URLLC. In a case that multiple HARQ processes operate in the BWP for URLLC, then the BPW for URLLC may remain active until all of the HARQ processes are completed. Additionally, in a case that repeated transmission is configured for URLLC and that the ACK is received before the repeated transmission is completed, the repeated transmission may be aborted, the HARQ process may be ended, and the BWP for URLLC may be deactivated. In a case that the BWP for URLLC is deactivated, the BWP for URLLC may be switched to the default BWP or to a BWP that has remained active until immediately before the BWP for URLLC is activated or to a BWP configured using the RRC information. Alternatively, the BWP for URLLC may remain active until the reception/transmission of traffic data for URLLC rather than until the completion of the HARQ process. In other words, the DCI is used for the ACK/NACK for the uplink data transmission, and thus the DCI format in which the ACK/NACK is notified is used again to notify whether to switch to the BWP for URLLC. In addition, the activation and deactivation of the BPW for URLLC may be performed in higher layer processing units, for example, in RLC PDU units or PDCP PDU units rather than in HARQ process units. The BWP for URLLC may be deactivated each time transmission of a higher layer processing unit is completed. The completion of the HARQ process may be determined by the inactivity timer, and the BWP may be switched based on the expiration of the inactivity timer. With an inactivity timer for URLLC, the BWP may be switched based on the expiration of the inactivity timer for URLLC.

First, a case will be described in which scheduling in accordance with the Compact DCI format is configured in multiple BWPs of the multiple BWPs configured in one serving cell. An example will be described in which, in the downlink, scheduling in accordance with the Compact DCI format is configured in multiple BWPs through PDCCH-config or PDSCH-config, corresponding to a configuration for each BWP, and in which scheduling is configured in the BWP3 and BWP4 in FIG. 10. In other words, in this example, FIG. 10 illustrates a configuration status of the downlink BWPs. In FIG. 10, in a case that the BWP1 corresponding to the initial BWP used first in a case that the serving cell is configured is switched to the BWP2 in accordance with DCI format 1_1, downlink URLLC data is generated, and then the base station apparatus performs scheduling in accordance with DCI format 1_c. In this case, the active BWP corresponds to the BWP2, and thus DCI format 1_c is transmitted on the PDCCH in the BWP2. In a case that the terminal apparatus detects DCI format 1_c by blind decoding, DCI format 1_c includes a field (one bit) specifying one of the BWP3 and the BWP4 in the Compact DCI format. In a case that the BWP3 is specified in this field, the terminal apparatus determines that the BWP2 is deactivated, whereas the BWP3 is activated. Furthermore, the terminal apparatus receives downlink data, based on the downlink grant in DCI format 1_c.

Furthermore, in a case that scheduling in accordance with the Compact DCI format is configured in three or more of the multiple BWPs configured in one serving cell, DCI format 1_c may be configured with a field (2 bits) specifying the BWPs to be activated. Consequently, the number of bits (for example, one of 0 bit, 1 bit, or 2 bits) in the field included in DCI format 1_c and specifying the BWPs to be activated may be determined depending on the number of BWPs in which scheduling in accordance with the Compact DCI format configured by RRC is performed.

Now, an example will be described in which, in the uplink, scheduling in accordance with the Compact DCI format is configured in multiple BWPs through PUSCH-config, corresponding to a configuration for each BWP, and in which scheduling is configured in the BWP3 and BWP4 in FIG. 10. In other words, in this example, FIG. 10 illustrates a configuration status of the uplink BWPs. In FIG. 10, a case is assumed in which the BWP1 corresponding to the initial BWP used first in a case that the serving cell is configured is switched to the BWP2 in accordance with DCI format 0_1. At this time, the terminal apparatus transmits a scheduling request after uplink URLLC data is generated. Here, the scheduling request may notify URLLC traffic by using the resource or parameter used for transmission of the scheduling request. Thereafter, the base station apparatus performs scheduling in accordance with DCI format 0_c. In this case, the base station apparatus transmits DCI format 0_c on the PDCCH in the active downlink BWP. In a case that the terminal apparatus detects DCI format 0_c by blind decoding, DCI format 0_c includes a field (1 bit) specifying one of the BWP3 and the BWP4 in the Compact DCI format. In a case that the BWP3 is specified in this field, the terminal apparatus determines that the BWP2 is deactivated, whereas the BWP3 is activated. Furthermore, the terminal apparatus transmits the uplink data, based on the uplink grant in DCI format 0_c.

Furthermore, in a case that scheduling in accordance with the Compact DCI format is configured in three or more of the multiple BWPs configured in one serving cell, DCI format 0_c may be configured with a field (2 bits) specifying the BWPs to be activated. Consequently, the number of bits (for example, one of 0 bit, 1 bit, or 2 bits) in the field included in DCI format 0_c and specifying the BWPs to be activated may be determined depending on the number of BWPs in which scheduling in accordance with the Compact DCI format configured by RRC is performed.

In the present embodiment, in a case that multiple BWPs are configured in one serving cell and that scheduling in the DCI format for URLLC is configured in some of the BWPs, switching to the BWP for URLLC is performed in a case that the DCI format for URLLC is detected. Consequently, the terminal apparatus can switch to the BWP for URLLC in accordance with the DCI format satisfying high reliability, allowing satisfaction of the requirement of high reliability from the downlink/uplink grant to the downlink data reception/uplink data transmission.

### Second Embodiment

The present embodiment describes a method for specifying switching to multiple BWPs with no change in the number of information bits in the DCI format satisfying high reliability. A communication system according to the present embodiment includes the base station apparatus 10 and the terminal apparatus 20 described with reference to FIG. 3, FIG. 4, FIG. 5, and FIG. 6. Differences from/additions to the first embodiment will be mainly described below.

As a method for specifying BWPs to be used for data transmission for URLLC, the base station apparatus utilizes one or both of the RRC information and the Compact DCI format to configure scheduling of the data transmission for URLLC. In particular, the RNTIs during scheduling in accordance with the Compact DCI format are designated by configuration of the PDCCH (PDCCH-config) or configuration of the PDSCH (PDSCH-config) for configuration for each downlink BWP (BWP-Downlink) for configuration of the serving cell (ServingCellConfig) included in the RRC information. On the other hand, in the uplink, the RNTIs during scheduling in accordance with the Compact DCI format are designated by configuration of the PUSCH (PUSCH-config) for configuration for each uplink BWP (BWP-Uplink in UplinkConfig) for configuration of the serving cell (ServingCellConfig) included in the RRC information. Scheduling of multiple URLLCs may be configured for the same BWP. The BWP-specific RNTIs are configured during scheduling in accordance with the Compact DCI, and thus the terminal apparatus determines the BWP to switch to (the BWP to be activated), based on the value of the RNTI used for CRC scrambling during the detection of the Compact DCI by blind decoding. For improved reliability during detection of the Compact DCI format, an RNTI with a large bit length may be used for scrambling. Additionally, scrambling may be performed using a RNTI with a small bit length appropriate to the Compact DCI format with a reduced amount of information.

A case will be described in which scheduling in accordance with the Compact DCI format is configured in multiple BWPs of the multiple BWPs configured in one serving cell. An example will be described in which, in the downlink, scheduling in accordance with the Compact DCI format is configured in multiple BWPs through PDCCH-config or PDSCH-config, corresponding to a configuration for each BWP, and in which scheduling is configured in the BWP3 and BWP4 in FIG. 10. In other words, in this example, FIG. 10 illustrates a configuration status of the downlink BWPs. In FIG. 10, in a case that the BWP1 corresponding to the initial BWP used first in a case that the serving cell is configured is switched to the BWP2 in accordance with DCI format 1_1, downlink URLLC data is generated, and then the base station apparatus performs scheduling in accordance with DCI format 1_c. In this case, the active BWP corresponds to the BWP2, and thus DCI format 1_c is transmitted on the PDCCH in the BWP2. In a case of detecting DCI format 1_c by blind decoding, the terminal apparatus determines which of the BWP3 and the BWP4 is designated by the RNTI used for CRC scrambling (exclusive logical operation) added to DCI format 1_c. Specifically, the RNTI configured is used to perform an exclusive logical operation on CRC bits used to check whether the DCI format has been detected as a result of blind decoding. Based on the bits resulting from the operation, whether an error is present or not is checked. In a case that no errors are determined to be present, the RNTI subjected to the exclusive logical operation with the CRC can be determined to be the RNTI used on the transmission side. Thus, the terminal apparatus determines the BWP designated by one of the RNTIs configured for the respective BWPs that is used on the transmission side. In a case that the BWP3 is designated by the RNTI, the terminal apparatus determines that the BWP2 is deactivated, whereas the BWP3 is activated. Furthermore, the terminal apparatus receives downlink data, based on the downlink grant in DCI format 1_c.

An example will be described in which, in the uplink, scheduling in accordance with the Compact DCI format is configured in multiple BWPs through PUSCH-config, corresponding to a configuration for each BWP, and in which scheduling is configured in the BWP3 and BWP4 in FIG. 10. In other words, in this example, FIG. 10 illustrates a configuration status of the uplink BWPs. In FIG. 10, a case is assumed in which the BWP1 corresponding to the initial BWP used first in a case that the serving cell is configured is switched to the BWP2 in accordance with DCI format 0_1. At this time, the terminal apparatus transmits a scheduling request after uplink URLLC data is generated. Here, the scheduling request may notify URLLC traffic by using the resource or parameter used for transmission of the scheduling request. Thereafter, the base station apparatus performs scheduling in accordance with DCI format 0_c. In this case, the base station apparatus transmits DCI format 0_c on the PDCCH in the active downlink BWP. In a case of detecting DCI format 0_c by blind decoding, the terminal apparatus determines which of the BWP3 and the BWP4 is designated by the RNTI used for CRC scrambling (exclusive logical operation) added to DCI format 0_c. Specifically, the RNTI configured is used to perform an exclusive logical operation on CRC bits used to check whether the DCI format has been detected as a result of blind decoding. Based on the bits resulting from the operation, whether an error is present or not is checked. In a case that no errors are determined to be present, the RNTI subjected to the exclusive logical operation with the CRC can be determined to be the RNTI used on the transmission side. Thus, the terminal apparatus determines the BWP designated by one of the RNTIs configured for the respective BWPs that is used on the transmission side. In a case that the BWP3 is designated by the RNTI, the terminal apparatus determines that the BWP2 is deactivated, whereas the BWP3 is activated. Furthermore, the terminal apparatus transmits the uplink data, based on the uplink grant in DCI format 0_c.

Note that the present embodiment is not limited to application to the Compact DCI format, and may be applied to DCI format 0_0/0_1/1_0/1_1. Note that the present embodiment is not limited to the Compact DCI format and may be applied to the repeated transmission of the DCI format, similarly to the first embodiment. Note that, in addition to the RNTI, the present embodiment may be based on the aggregation level being at a prescribed value or a larger, or the search space (only the common search space or only the UE-specific search space), or the DCI format (DCI format 0_0 or DCI format 1_0).

In the present embodiment, in a case that multiple BWPs are configured in one serving cell and that scheduling in accordance with the DCI format for URLLC (as an example, the Compact DCI format, the DCI scrambled with the RNTI for URLLC, or the like) is configured in some of the BWPs, switching to the BWP is performed by using the RNTI used to transmit the DCI format for URLLC. Consequently, the terminal apparatus can switch to the BWP for URLLC in accordance with the DCI format satisfying high reliability, allowing satisfaction of the requirement of high reliability from the downlink/uplink grant to the downlink data reception/uplink data transmission.

### Third Embodiment

The present embodiment describes a method for notifying a request for switching to the BWP in accordance with the uplink control information. A communication system according to the present embodiment includes the base station apparatus 10 and the terminal apparatus 20 described with reference to FIG. 3, FIG. 4, FIG. 5, and FIG. 6. Differences from/additions to the previous embodiments will be mainly described below.

Description is given using a sequence chart of FIG. 7. In S203, the terminal apparatus receives SR resource configuration information requesting BWP switching and SR resource configuration information not requesting BWP switching. In a case that data that is not URLLC is generated, the terminal apparatus generates an SR signal in a specified PUCCH format based on the SR configuration not requesting BWP switching (S204). Here, the uplink data that is not URLLC being generated may refer to providing a transport block of data for which the higher layer is not URLLC. The terminal apparatus transmits the SR signal on the uplink control channel, based on the SR configuration not requesting BWP switching (S205). In a case of detecting an SR based on the SR transmission configuration not requesting BWP switching, the base station apparatus transmits the UL Grant to the terminal apparatus on the downlink control channel by using DCI format 0_0/0_1, based on the DCI format (S206). The description of the subsequent operation is similar to the above description of FIG. 7, and is thus omitted.

On the other hand, in a case that URLLC data is generated, the terminal apparatus generates an SR signal in the specified PUCCH format, based on the SR configuration requesting BWP switching (S204). Here, URLLC uplink data being generated may refer to providing a transport block of data for which the higher layer is URLLC. Based on the SR configuration requesting BWP switching, the terminal apparatus transmits a signal of SR on the uplink control channel (S205). In a case of detecting an SR based on SR transmission configuration requesting BWP switching, the base station apparatus transmits the UL Grant in the DCI format for URLLC to the terminal apparatus on the downlink control channel (S206). Here, the DCI format for URLLC may be the Compact DCI format, repetitive transmissions of the DCI format, the DCI format for which the RNTI configured for URLLC has been used, or a combination of at least two of the aggregation level being at a prescribed value or larger, the search space (only the common search space or only the UE-specific search space), and the DCI format (DCI format 0_0 or DCI format 1_0). The description of the subsequent operation is similar to the above description of FIG. 7, and is thus omitted.

Here, the data for URLLC may be configured to differ from transmission of data that is not URLLC in one of scheduling information indicated by the UL Grant, a method for specifying the MCS (specification using multiple tables indicative of a difference in maximum/minimum spectral efficiency, a difference in block error rate of a target, a difference in modulation order available, and the like), and a method for specifying the HARQ process number.

Here, the information regarding resources and parameters for an SR requesting BWP switching may be configured through PUCCH-config corresponding to PUCCH configuration information. As described above, the PUCCH-config includes a format used, a PUCCH resource, association between the resource and the format, configuration of intra-slot hopping, and SR configuration information. The SR configuration information includes a scheduling request ID (SchedulingRequestId), the period and offset of the scheduling request, and the information of the PUCCH resource to be used. In the PUCCH-config, the scheduling request ID of an SR requesting BWP switching may be configured, and in a case of receiving the SR based on the scheduling request ID configured, the base station apparatus determines the SR to request BWP switching. Note that the scheduling request ID configured in PUCCH-config may indicate an SR that does not require BWP switching.

Note that, in a case of receiving the SR requesting BWP switching, the base station apparatus may notify BWP switching through the information included in the DCI format, or may notify BWP switching by using the method described in the first embodiment or the second embodiment. In addition, the RRC signaling may be used to pre-configure switching of the active BWP by using the SR requesting BWP switching.

In the present embodiment, in the uplink, configurations of SRs requesting BWP switching and SRs not requesting BWP switching are present, and in a case of transmitting an SR for data transmission for URLLC, the terminal apparatus transmits an SR requesting BWP switching. As a result, the base station apparatus can determine whether the data held by the terminal apparatus is URLLC data, and can indicate BWP switching and can also satisfy the high reliability requirement in uplink URLLC data transmission.

### Fourth Embodiment

The present embodiment describes a method for notifying the ACK of configured grant type1/type2 in the uplink. A communication system according to the present embodiment includes the base station apparatus 10 and the terminal apparatus 20 described with reference to FIG. 3, FIG. 4, FIG. 5, and FIG. 6. Differences from/additions to the previous embodiments will be mainly described below.

In a sequence chart of uplink data transmission according to configured grant in FIG. 9, no ACK is transmitted, but in the present embodiment, the ACK is efficiently transmitted. Regardless of whether the uplink data transmission is based on dynamic scheduling grant or configured grant, feedback is provided in the DCI format. However, for data transmission through configured grant, only the NACK is notified, as previously described. However, in a case that the base station apparatus fails to detect the data transmission through the configured grant and does not transmit the NACK, the terminal apparatus is to receive the NACK, but determines the NACK to be an ACK. Additionally, in a case that the base station apparatus fails to detect the data transmission through configured grant and transmits the DCI format notifying the NACK, but in a case that the terminal apparatus fails to blind-decode the DCI format, the terminal apparatus is to receive the NACK, but determines the NACK to be an ACK. To avoid these issues, notification of the ACK needs to be performed. However, in a case that the ACK is assumed to be notified in the DCI format addressed to each terminal apparatus, a large number of terminal apparatuses are present that perform data transmission through configured grant, concentration at the same slot leads to the need for transmission of a large number of DCI formats, and this results in insufficient resources for the PDCCH. Accordingly, the present embodiment describes an example in which multiple terminal apparatuses are grouped and the ACK is transmitted in units of groups.

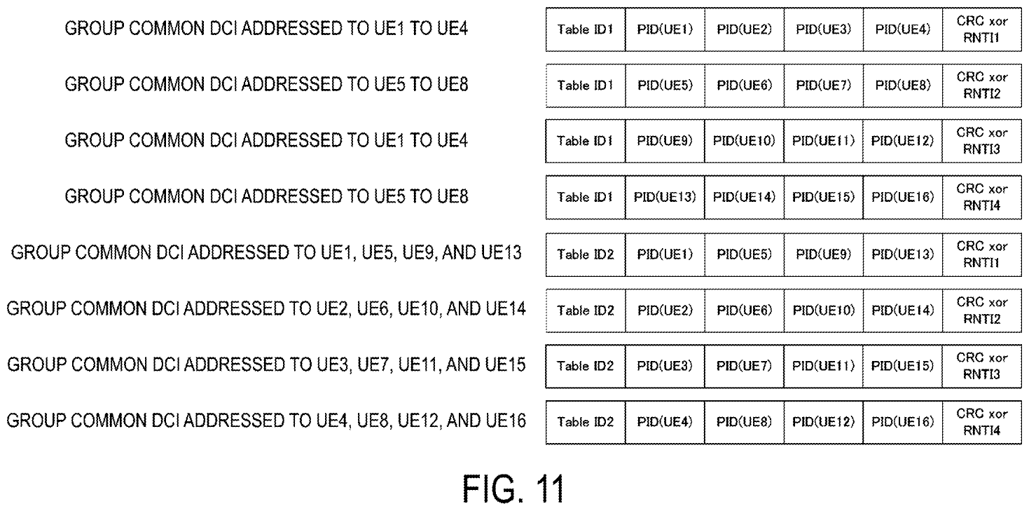

FIG. 11 illustrates an example of ACK transmission for uplink configured grant according to a fourth embodiment. In a case that the ACK for the data transmission through Configured grant type1/type2 is notified, notification of the process ID corresponding to the ACK needs to be performed, as well as transmission of the ACK/NACK. Configured grant type1/type2 may include multiple processes, and the HARQ process ID (hereinafter referred to as the PID) is determined depending on an OFDM symbol number to be transmitted. In a case that transmission is performed in multiple OFDM symbols, the PID is determined by the leading OFDM symbol number. Additionally, in a case that repeated transmission of the same data is configured in Configured grant type1/type2, the PID is determined by the leading OFDM symbol number of the first transmission. In a case that HARQ processes with multiple PIDs are executed, which of the processes the ACK is intended needs to be indicated. Thus, in the present embodiment, the process ID corresponding to the ACK is specified for each UE.

In FIG. 11, a Group Common DCI format (GC-DCI format) including ACKs for grouped multiple terminal apparatuses corresponds to information for each row. That is, the first row in FIG. 11 is one GC-DCI format, and contains PIDs corresponding to ACKs directed to UE1 to UE4. Furthermore, the GC-DCI format of the present embodiment includes a table ID and a CRC added for error correction coding. First, for the PIDs corresponding to the ACKs, the ACKs are not transmitted at the same timing to all of the grouped terminal apparatuses. Thus, the field for each terminal apparatus to be notified of the ACK includes the information of the PID corresponding to the ACK, and the field for each of the terminal apparatuses that need not be notified of the ACK includes the PID that is not currently in execution. After the data transmission through configured grant type1/type 2 (while the configuredGrantTimer is in execution), each terminal apparatus may blind-decode the GC-DCI format for notifying the ACK. In a case that the data transmission through configured grant type1/type2 is not performed (configuredGrantTimer is not in execution), then each terminal apparatus may not blind-decode the GC-DCI format for notifying the ACK. Additionally, each terminal apparatus may receive parameters for detecting the GC-DCI format through RRC signaling. In other words, the RRC signaling may be used to notify the offset (ordinal information) at which the information addressed to the terminal apparatus is included within the Table IDs, the RNTIs, and the GC-DCI format for which the ACK addressed to the terminal apparatus is notified, and the number of bits in each PID.

In the configured grant type1/type2, the number of process IDs varies with terminal apparatus due to RRC signaling. However, in a case that the GC-DCI format includes the PIDs corresponding to the respective terminal apparatuses and to each of which the ACK is notified and that the PIDs include different numbers of bits, then this configuration is complicated. Thus, the number of bits in the PID included in the GC-DCI format and corresponding to each of the terminal apparatuses may be fixed. Additionally, the number of bits in the PID included in the GC-DCI format and corresponding to each of the terminal apparatuses may be variable. In this case, the offset at which the information addressed to the terminal apparatus is included within the GC-DCI format need not indicate the ordinal number of the user but may indicate the ordinal number of the bit. The number of active bits containing information addressed to the terminal apparatus in the GC-DCI format may be determined by the number of HARQ processes in configured grant type1/type2 configured by RRC signaling.

In FIG. 11, grouping of UE1 to UE4, UE5 to UE8, UE9 to UE12, and UE13 to UE16 is defined as pattern 1 (Table ID1), and grouping of UE1/5/9/13, UE2/6/10/14, UE3/7/11/15, and UE4/8/12/16 is defined as pattern 2 (Table ID2). In a case that UE1 detects the GC-DCI format for notifying the ACK and that the RNTI1 is used to indicate Table1, UE1 determines that the offset is the first. On the other hand, in a case that UE1 detects the GC-DCI format for notifying the ACK and that the RNTI2 and table1 or RNTI3 and tablet are detected, UE1 determines that no information is addressed to the terminal apparatus. In this way, the RNTI and the table ID are used to determine the presence/absence of the ACK and the offset. By thus providing multiple table IDs, the ACKs can be grouped in various combinations. For example, with only table ID1, in a case that UE1 and UE5 are transmitted at the same timing (the same slot/the same OFDM symbol), grouping is disabled. However, with table ID2 prepared, grouping is enabled for transmission.

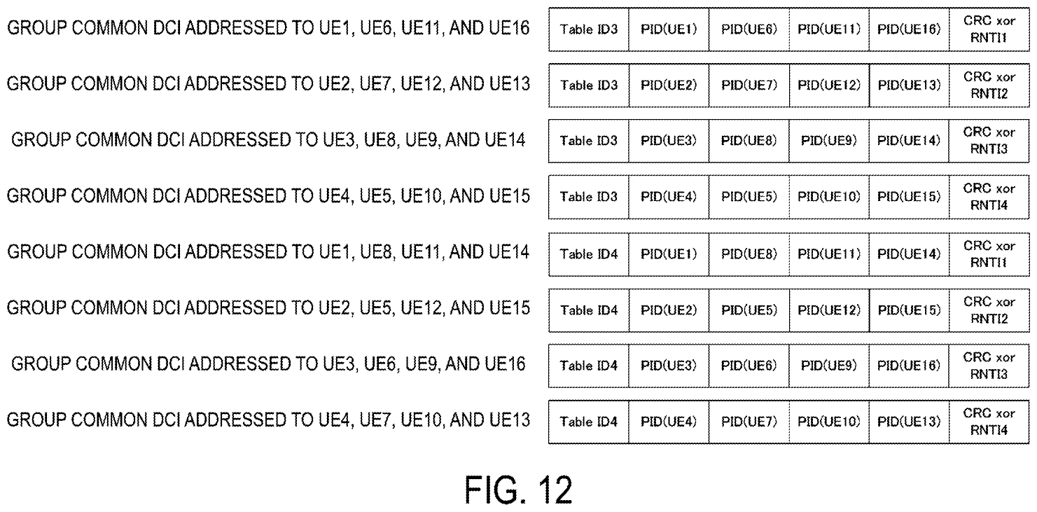

FIG. 12 illustrates an example of ACK transmission through uplink configured grant according to the fourth embodiment. FIG. 12 indicates grouping different from the grouping in FIG. 11, and thus using a combination of FIG. 11 and FIG. 12 enables grouping in various combinations. The number of table IDs may be notified by the base station apparatus through RRC signaling, and the number of bits in the field of the table ID may be determined. Additionally, the number of information bits in the GC-DCI format for notifying the ACK is dependent on the number of terminal apparatuses to be grouped and the number of bits in the process ID. Thus, in a case of determining the number of terminal apparatuses to be grouped and the number of bits in the process ID, the base station apparatus may realize high reliability by setting the number of terminal apparatuses to be grouped and the number of bits in the process ID less than the number of information bits in DCI format 0_0/1_0. Additionally, in a case of determining the number of terminal apparatuses to be grouped and the number of bits in the process ID, the base station apparatus may prevent an increase in the number of times of blind decoding by setting the number of terminal apparatuses to be grouped and the number of bits in the process ID equal to the number of information bits in another DCI format such as the number of information bits in DCI format 0_0/1_0 or the number of information bits in the Compact DCI. Additionally, in the related art, the ACK addressed to a single terminal apparatus is transmitted by using DCI format 0_0/1_0. However, in a case that the number of information bits in the GC-DCI format for notifying the ACK is equal to or less than the number of information bits in DCI format 0_0/1_0, no terminal apparatus is to be grouped and spectral efficiency can be maintained even in a case that the GC-DCI format for notifying the ACK to the single terminal apparatus is transmitted.

In the present embodiment, the process IDs corresponding to the ACKs through the uplink configured grant type1/type2 are grouped and notified. As a result, even with an increased number of terminal apparatuses performing data transmission through configured grant type1/type2, a decrease in spectral efficiency of the PDCCH can be suppressed.

### Fifth Embodiment

The present embodiment describes a method for collectively notifying grouped terminal apparatuses of the ACK through the uplink configured grant type1/type2. A communication system according to the present embodiment includes the base station apparatus 10 and the terminal apparatus 20 described with reference to FIG. 3, FIG. 4, FIG. 5, and FIG. 6. Differences from/additions to the previous embodiments will be mainly described below.

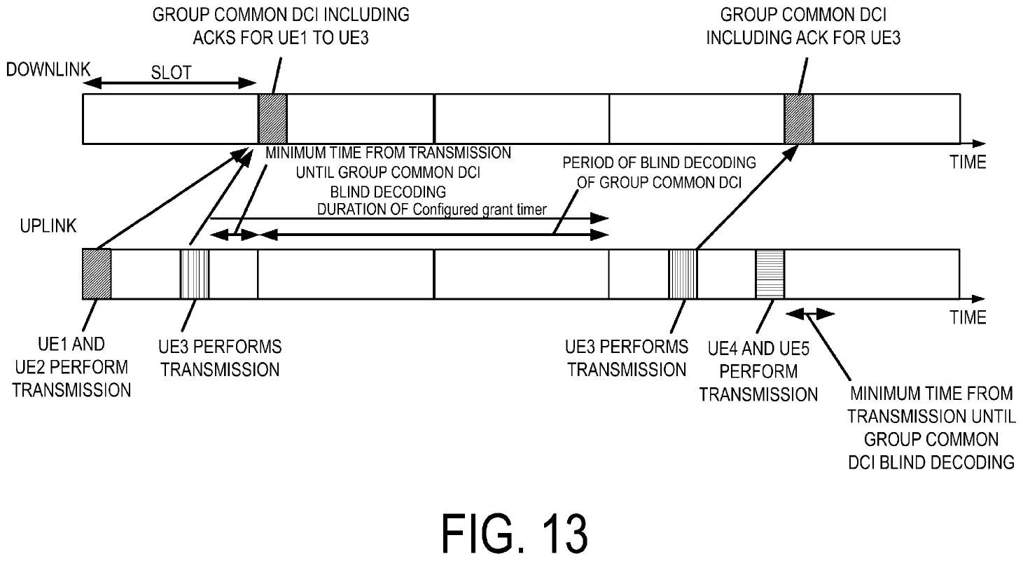

FIG. 13 illustrates an example of ACK transmission through the uplink configured grant according to the fifth embodiment. In the figure, UE1 and UE2 perform data transmission through configured grant type1/type2 in the same OFDM symbol (one or more OFDM symbols) in the same slot, and UE3 further performs data transmission through configured grant type1/type2 in a different OFDM (one or more OFDM symbols) in the same slot. In this case, the base station apparatus uses the GC-DCI format for notifying the ACK as in the preceding embodiment to notify UE1 to UE3 of the PID corresponding to the ACK. On the other hand, in another slot in FIG. 11, the UE3 performs data transmission through configured grant type1/type2, and in a different OFDM (one or more OFDM symbols) in the same slot, UE4 and UE5 perform data transmission through configured grant type1/type2. In this case, the base station apparatus preferably uses the GC-DCI format for notifying the ACK as in the preceding embodiment to notify UE3 to UE5 of the PID corresponding to the ACK. However, in a case that the time from the data transmission timing for UE4 and UE5 to the notification timing for the GC-DCI format for notifying the ACK is very short, the processing time of the base station apparatus is insufficient, and grouping is disabled.

Thus, the present embodiment configures the minimum time (hereinafter referred to as t_min) from the time when the terminal apparatus performs data transmission through configured grant type1/type2 until the terminal apparatus detects the GC-DCI format for notifying the ACK. Specifically, the base station apparatus notifies the t_min through RRC signaling. After data transmission through configured grant type1/type2, the terminal apparatus may skip the blind decoding (monitoring) of the GC-DCI format until t_min has elapsed. Additionally, after the data transmission through configured grant type1/type2, the terminal apparatus may start the timer until t_min and enter the DRX until the timer expires. In addition, the terminal apparatus may ignore the GC-DCI format detected after the data transmission through configured grant type1/type2 and before t_min. However, in a case that multiple HARQ processes are present, the time of t_min is managed in units of HARQ processes, and assuming that the data transmission through configured grant type1/type2 is PID1, in a case that the information of PID1 is included in the GC-DCI format detected after the data transmission and before t_min, the terminal apparatus may ignore the GC-DCI format.

In the present embodiment, the ACK through the uplink configured grant type1/type2 is collectively notified to the grouped terminal apparatuses. Additionally, in a case of grouping, the minimum time from the data transmission through configured grant type1/type2 until the GC-DCI format is configured. As a result, even with an increased number of terminal apparatuses performing data transmission through configured grant type1/type2, a decrease in spectral efficiency of the PDCCH can be suppressed.

Note that the embodiments herein may be applied by combining multiple embodiments, or only each of the embodiments may be applied.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily read into a volatile memory, such as a Random Access Memory (RAM) while being processed, or stored in a non-volatile memory, such as a flash memory, or a Hard Disk Drive (HDD), and then read by the CPU to be modified or rewritten, as necessary.

Note that the apparatuses in the above-described embodiments may be partially enabled by a computer. In that case, a program for realizing the functions of the embodiments may be recorded on a computer readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, and the like.

Moreover, the “computer-readable recording medium” may include a medium that dynamically retains a program for a short period of time, such as a communication line that is used for transmission of the program over a network such as the Internet or over a communication line such as a telephone line, and may also include a medium that retains a program for a fixed period of time, such as a volatile memory within the computer system for functioning as a server or a client in such a case. Furthermore, the above-described program may be one for realizing some of the above-described functions, and also may be one capable of realizing the above-described functions in combination with a program already recorded in a computer system.

Furthermore, each functional block or various characteristics of the apparatuses used in the above-described embodiments may be implemented or performed on an electric circuit, that is, typically an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. Furthermore, in a case that with advances in semiconductor technology, a circuit integration technology appears that replaces the present integrated circuits, it is also possible to use an integrated circuit based on the technology.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

### INDUSTRIAL APPLICABILITY

An aspect of the present invention can be preferably used in a base station apparatus, a terminal apparatus, and a communication method.

1. A terminal apparatus for communicating with a base station apparatus in at least one serving cell, the terminal apparatus comprising:
a control information detection unit configured to detect first Downlink Control Information (DCI) and second DCI notifying Radio Resource Control (RRC) information and an uplink grant; and
a transmitter configured to perform data transmission indicated in the first DCI or the second DCI, wherein
at least a first BandWidth Part (BPW) and a second BPW are configured for the at least one serving cell according to the first RRC information,
the second DCI is associated with the second BWP according to the second RRC information,
an amount of information of the first DCI differs from an amount of information of the second DCI,
the second DCI does not include a switching information bit for switching between the first BWP and the second BWP,
the transmitter performs the data transmission in a BWP that is active and corresponds to one of the first BWP and the second BWP, and
in a case that the control information detection unit detects the second DCI in the first BWP, the second BWP is activated and the data transmission is performed in the second BWP.

2. The terminal apparatus according to claim 1, wherein,
in a case that the second BWP is active and that HARQ processes used for the data transmission in the second BWP are all completed, the second BWP is deactivated.

3. The terminal apparatus according to claim 1, wherein,
in a case that the control information detection unit detects the second DCI in the first BWP,
an inactivity timer is started, and the second BWP is deactivated in a case that the inactive timer expires.

4. The terminal apparatus according to claim 1, wherein,
in a case that a third BWP is further configured according to the first RRC information,
an information field, configured in the second DCI, for indicating one of a plurality of the BWPs is added.

5. The terminal apparatus according to claim 4, wherein,
in a case that a fourth BWP is further configured according to the first RRC information,
a bit length of the added information field for indicating the one of the plurality of the BWPs is changed.

6. A terminal apparatus for communicating with a base station apparatus in at least one serving cell, the terminal apparatus comprising:
a control information detection unit configured to detect first Downlink Control Information (DCI) and second DCI notifying Radio Resource Control (RRC) information and an uplink grant; and
a transmitter configured to perform data transmission indicated in the first DCI or the second DCI, wherein
at least a first BandWidth Part (BPW) and a second BWP are configured for the at least one serving cell according to the first RRC information,
at least a first RNTI and a second RNTI are configured as Radio Network Temporary Identifiers (RNTIs) to be used in the second DCI according to the third RRC information,
the first BWP is activated in a case that use of the first RNTI in the second DCI is detected, and
the second BWP is activated in a case that use of the first RNTI in the second DCI is detected.

7. A terminal apparatus for communicating with a base station apparatus in at least one serving cell, the terminal apparatus comprising:
a control information detection unit configured to detect Radio Resource Control (RRC) information; and
a transmitter, wherein
at least a first BandWidth Part (BPW) and a second BWP are configured for the at least one serving cell according to first RRC information,
at least a resource for a first scheduling request and a resource for a second scheduling request are configured according to fourth RRC information,
an uplink transmission using the first BWP is requested in a case that the resource for the first scheduling request is used, and
an uplink transmission using the second BWP is requested in a case that the resource for the second scheduling request is used.

8. A base station apparatus for communicating with a terminal apparatus in at least one serving cell, the base station apparatus comprising:
a controller configured to control generation of first Downlink Control Information (DCI) and second DCI for notifying Radio Resource Control (RRC) information and an uplink grant;
a transmitter configured to transmit one of the first DCI, the second DCI, and the RRC information; and
a receiver configured to receive a signal transmitted from the terminal apparatus, wherein
at least a first BandWidth Part (BPW) and a second BPW are configured for the at least one serving cell according to first RRC information,
the second DCI is associated with the second BWP according to second RRC information,
an amount of information of the first DCI differs from an amount of information of the second DCI,
the second DCI does not include a switching information bit for switching between the first BWP and the second BWP,
the receiver receives a signal transmitted using a BWP that is active and corresponds to one of the first BWP and the second BWP from the terminal apparatus, and
in a case that the second DCI is transmitted in the first BWP, the second BWP is activated, and the signal transmitted from the terminal apparatus is received in the second BWP.
